(19) United States
(12) Patent Application Publication
(10) Pub. No.: US 2019/0126626 A1
(43) Pub. Date: May 2, 2019

(54) CARTRIDGE

(71) Applicant: SEIKO EPSON CORPORATION, Tokyo (JP)

(72) Inventors: Taku ISHIZAWA, Matsumoto-shi (JP); Tadahiro MIZUTANI, Shiojiri-shi (JP); Noriyuki FUKASAWA, Shiojiri-shi (JP); Shun OYA, Kiso-machi (JP)

(73) Assignee: SEIKO EPSON CORPORATION, Tokyo (JP)

(21) Appl. No.: 16/172,319

(22) Filed: Oct. 26, 2018

(30) Foreign Application Priority Data
Oct. 30, 2017 (JP) 2017-208820

(51) Int. Cl. B41J 2/175

(52) U.S. Cl. CPC B41J 2/17513; B41J 2/17526; B41J 2/17553; B41J 2/1752

(57) ABSTRACT

The likelihood that a liquid discharge failure will occur in a cartridge including a liquid absorber is reduced. A cartridge includes: a liquid supply unit configured to receive a liquid supply needle; a first chamber in which a liquid absorber is arranged; a second chamber in which the liquid absorber is not arranged and the liquid supply unit is provided; and a filter that is provided between the first chamber and the second chamber. The length of the filter in a longitudinal direction is larger than half the length of the liquid absorber in the longitudinal direction, and the capillary force of the liquid absorber in a bottom face portion is larger than the capillary force of the liquid absorber in a central portion in a height direction.

### CROSS REFERENCE TO RELATED APPLICATIONS

This application claims priority to Japanese Application No. 2017-208820 filed on Oct. 30, 2017. The entire disclosure of this Japanese application is expressly incorporated by reference herein.

### BACKGROUND

### 1. Technical Field

The present invention relates to a cartridge.

### 2. Related Art

A cartridge in which a liquid absorber for retaining liquid is arranged inside a liquid containing chamber of the cartridge has been known as a cartridge used in liquid ejection devices such as an inkjet printer (refer to Japanese Patent No. 3,278,410, JP-A-4-173343, JP-A-2006-76313, JP-A-2006-76314). A porous material or a fibrous material is used as the liquid absorber, for example. The liquid retained in the liquid absorber is suctioned by a liquid ejection device from a liquid supply unit provided in the bottom face or the like of the cartridge, and is supplied to the liquid ejection device.

In such a cartridge, there is a problem in that liquid is likely to remain in a portion, of the liquid absorber, that is far from the liquid supply unit due to the capillary force of the liquid absorber. Therefore, the inventors have studied a configuration in which a large filter is arranged between a liquid containing chamber and a liquid supply unit, and the liquid is allowed to flow to the liquid supply unit via the filter such that the liquid easily flows from the liquid absorber to the liquid supply unit. However, the inventors have found out that there is a problem in that, when such a large filter is provided, in the case where the cartridge is subjected to an impact due to being dropped or the like, air that exists on the liquid absorber side is likely to move toward the liquid supply unit side via the filter, and as a result, there is a possibility that a discharge failure will occur.

### SUMMARY

An advantage of some aspects of the invention is to solve at least some of the above-described problems, and can be realized in the following aspects.

(1) According to a first aspect of the invention, a cartridge that is to be attached to a liquid ejection device including a liquid supply needle is provided. The cartridge includes: a liquid supply unit configured to receive the liquid supply needle; a first chamber in which a liquid absorber is arranged; a second chamber in which the liquid absorber is not arranged and the liquid supply unit is provided; and a filter that is provided between the first chamber and the second chamber. The length of the filter in a longitudinal direction is larger than half the length of the liquid absorber in the longitudinal direction, and the capillary force of a bottom face portion of the liquid absorber is larger than the capillary force of a central portion of the liquid absorber in a height direction.

With this cartridge of such an aspect, since the length of the filter in the longitudinal direction is larger than half the length of the liquid absorber in the longitudinal direction, liquid can be suppressed from remaining in a portion, of the liquid absorber, far from the liquid supply unit. Also, since the capillary force of the bottom face portion of the liquid absorber is larger than the capillary force of the central portion of the liquid absorber in a height direction, ink can be preferably retained in the liquid absorber in the vicinity of the filter. As a result, even in a case where the area of the filter is large, the air that exists on the liquid absorber side is unlikely to move to the second chamber side (liquid supply unit side). Therefore, the occurrence of a liquid discharge failure can be suppressed.

(2) In the cartridge of the above-described aspect, the capillary force of the filter may be larger than the capillary force of the liquid absorber. With this cartridge of such an aspect, the air inside the liquid absorber is unlikely to enter the second chamber.

(3) In the cartridge of the above-described aspects, a level difference portion that protrudes downward may be formed in a ceiling surface of the first chamber. With this cartridge of such an aspect, the capillary force of the bottom face portion of the liquid absorber can be easily increased.

(4) In the cartridge of the above-described aspects, the maximum width of the level difference portion in a transverse direction of the filter may be larger than the maximum width of the filter in the transverse direction. With this cartridge of such an aspect, the capillary force of the bottom face portion of the liquid absorber can be preferably increased.

(5) In the cartridge of the above-described aspects, a side wall of the first chamber is provided with a protrusion that protrudes toward the inside of the first chamber, the protrusion extends in a vertical direction, and the protrusion may include a part inclined such that a projection amount increases from an upper portion toward a bottom portion of the first chamber. With this cartridge of such an aspect, because the liquid absorber can be compressed more on the bottom portion side of the first chamber, the capillary force of the liquid absorber can be increased toward the bottom portion side. Therefore, inside the liquid absorber, liquid can be allowed to flow smoothly from the upper portion side toward the bottom portion side. Also, as a result of providing the protrusion on the side wall of the first chamber, a space is formed between the liquid absorber and the side wall, and therefore the liquid inside the liquid absorber can seep out to the space when the air inside the liquid absorber expands or the like. Accordingly, the liquid inside the liquid containing chamber can be suppressed from leaking to the outside due to an increase in the liquid surface of the liquid. Also, the liquid that has seeped out to the above-described space is again absorbed by the liquid absorber, and therefore the liquid can be suppressed from remaining inside the cartridge.

The invention may be realized in various modes other than the mode as a cartridge described above. For example, the invention may be realized as modes such as a liquid ejection device including the cartridge and a liquid ejection system including the cartridge and the liquid ejection device.

### BRIEF DESCRIPTION OF THE DRAWINGS

The invention will be described with reference to the accompanying drawings, wherein like numbers reference like elements.

FIG. 1 is a perspective view illustrating a configuration of a liquid ejection system.

FIG. 2 is a top view of a carriage.

FIG. 3 is a perspective view of the carriage.

FIG. 4 is a first perspective view of the cartridge.

FIG. 5 is a second perspective view of the cartridge.

FIG. 6 is an exploded perspective view of the cartridge.

FIG. 7 is a cross-sectional view taken along line VII-VII in FIG. 2.

FIG. 8 is a cross-sectional view taken along line VIII-VIII in FIG. 2.

FIG. 9 is a perspective view of a liquid containing chamber viewed from an upper face side.

FIG. 10 is a plan view of the liquid containing chamber as seen in a top view.

FIG. 11 is a cross-sectional view taken along line XI-XI in FIG. 10.

FIG. 12 is a cross-sectional view taken along line XII-XII in FIG. 10.

FIG. 13 is a cross-sectional view taken along line XIII-XIII in FIG. 10.

FIG. 14 is a plan view of a lid member as seen in a top view.

FIG. 15 is a plan view of the lid member as seen in a bottom view.

FIG. 16 is a perspective view illustrating a lower face side of the lid member.

FIG. 17 is a perspective view illustrating a cross-sectional structure of the inside of the cartridge.

FIG. 18 is a perspective view illustrating a structure of a bubble trap chamber.

FIG. 19 is a cross-sectional view taken along line XIX-XIX in FIG. 18.

FIG. 20 is a cross-sectional view taken along line XX-XX in FIG. 18.

FIG. 21 is an X-Z cross-sectional view in the vicinity of a liquid supply unit.

FIG. 22 is a cross-sectional view of a cartridge in a second embodiment.

FIG. 23 is a perspective view of the cartridge shown in FIG. 22.

FIG. 24 is a cross-sectional view of a cartridge in a third embodiment.

FIG. 25 is a perspective view of the cartridge shown in FIG. 24.

FIG. 26 is a cross-sectional view of a cartridge in a fourth embodiment.

FIG. 27 is a perspective view of the cartridge shown in FIG. 26.

FIG. 28 is a cross-sectional view of a cartridge in a fifth embodiment.

### DESCRIPTION OF EXEMPLARY EMBODIMENTS

### A. First Embodiment

A1. Configuration of Liquid Ejection System

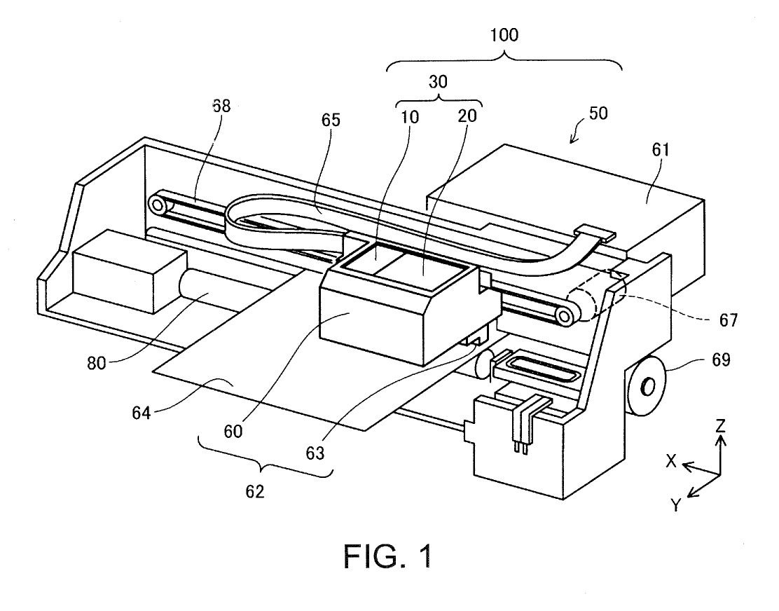

FIG. 1 is a perspective view illustrating a configuration of a liquid ejection system 100. In FIG. 1, X, Y, and Z axes that are orthogonal to each other are shown. The X, Y, and Z axes in FIG. 1 correspond to the X, Y, and Z axes in the other diagrams. The X, Y, and Z axes are added, as necessary, to diagrams that will be shown in the following. A direction along the X axis is an X direction, a direction along the Y axis is a Y direction, and a direction along the Z axis is a Z direction. Also, one direction in the X direction is a +X direction, and the other direction in the X direction is a −X direction. Also, one direction in the Y direction is a +Y direction, and the other direction in the Y direction is a −Y direction. Also, one direction in the Z direction is a +Z direction, and the other direction in the Z direction is a −Z direction. In a state in which the liquid ejection system 100 is installed on an X-Y plane (horizontal plane) that is parallel to the X direction and the Y direction, the Z direction is a vertical direction, the +Z direction is an antigravity direction (upward direction), and the −Z direction is a gravity direction (downward direction). Also, in the liquid ejection system 100, the Y direction is a front rear direction, and the X direction is a width direction (left and right direction).

The liquid ejection system 100 includes a cartridge set 30 constituted by a first cartridge 10 and a second cartridge 20, and a liquid ejection device 50. In the liquid ejection system 100, the two types of cartridges 10 and 20 are detachably attached by a user to a cartridge holder 60 of the liquid ejection device 50. The liquid ejection device 50 is an inkjet printer that can print on paper whose maximum size is A3 or the like. The liquid ejection device 50 includes a head 63 that can eject three or more types of liquid. In the present embodiment, the head 63 can eject four types of ink (black ink, yellow ink, magenta ink, and cyan ink) whose colors are different.

The first cartridge 10 and the second cartridge 20 are attached to the cartridge holder 60 side by side in the X direction. The first cartridge 10 contains one type of liquid. In the present embodiment, the first cartridge 10 contains black ink. The second cartridge 20 contains three types of ink, namely yellow ink, magenta ink, and cyan ink. That is, the second cartridge 20 contains a plurality of types of liquid, out of the types of liquid that remain when excluding the one type of liquid contained in the first cartridge 10 from the three or more types of liquid that the head 63 can eject (four types in the present embodiment). Here, the number and types of the cartridges to be attached to the cartridge holder 60 are not limited to those in the present embodiment. For example, two first cartridges 10 and one second cartridge 20 may be attached to the cartridge holder 60. In this case, the configuration of the cartridge holder 60 may be changed according to the number of cartridges. Also, the types of liquid to be contained in the first cartridge 10 and the second cartridge 20 are not limited to those in the present embodiment. For example, ink of another color (light magenta or light cyan, for example) may be contained in the second cartridge 20. Also, the second cartridge 20 may be configured to contain two types of liquid, or may be configured to contain four or more types of liquid.

The liquid ejection device 50 includes a controller 61 and a carriage 62 including the cartridge holder 60, in addition to the cartridge holder 60. The carriage 62 includes the above-described head 63. The head 63 suctions ink from the first cartridge 10 and the second cartridge 20 that are attached to the cartridge holder 60 via later described liquid supply needles, and discharges (supplies) the ink onto a print medium 64 such as paper or a label. Accordingly, data such as a character, a diagram, or an image is printed on the print medium 64.

The controller 61 controls units of the liquid ejection device 50. The carriage 62 is configured to move relative to the print medium 64. The head 63 includes an ink discharging mechanism that discharges ink supplied from the cartridges 10 and 20 attached to the cartridge holder 60 onto the print medium 64. The controller 61 and the carriage 62 are electrically connected via a flexible cable 65, and the ink discharging mechanism of the head 63 operates based on a control signal from the controller 61.

In the present embodiment, the carriage 62 includes the head 63 and the cartridge holder 60. The type of the liquid ejection device 50 in which the cartridge 20 is attached to the cartridge holder 60 on the carriage 62 that moves the head 63, in this way, is also referred to as an “on-carriage type”. In other embodiments, a configuration may be adopted in which a cartridge holder 60 that does not move is configured as a part that is different from a carriage 62, and ink is supplied from a cartridge 20 attached to the cartridge holder 60 to a head 63 of the carriage 62 via a flexible tube. This type of printer is also referred to as an “off-carriage type”.

The liquid ejection device 50 includes a main scanning feed mechanism and a sub scanning feed mechanism for realizing printing onto the print medium 64 by relatively moving the carriage 62 and the print medium 64. The main scanning feed mechanism of the liquid ejection device 50 includes a carriage motor 67 and a drive belt 68. Power from the carriage motor 67 is transmitted to the carriage 62 via the drive belt 68, and as a result, the carriage 62 moves back and forth along the X direction. The sub scanning feed mechanism of the liquid ejection device 50 includes a conveyance motor 69 and a platen 80, power from the conveyance motor 69 is transmitted to the platen 80, and as a result, the print medium 64 is conveyed in the +Y direction. The direction in which the carriage 62 moves back and forth may also be referred to as a main scanning direction, and the direction in which the print medium 64 is conveyed may also be referred to as a sub scanning direction. In the present embodiment, the main scanning direction is the X direction, and the sub scanning direction is the Y direction. The carriage motor 67 of the main scanning feed mechanism and the conveyance motor 69 of the sub scanning feed mechanism operate based on control signals from the controller 61.

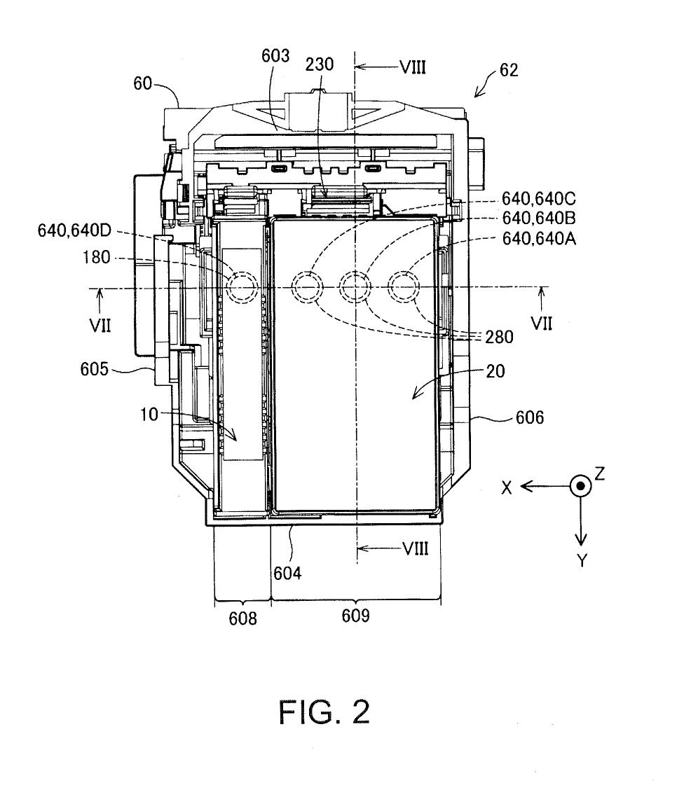

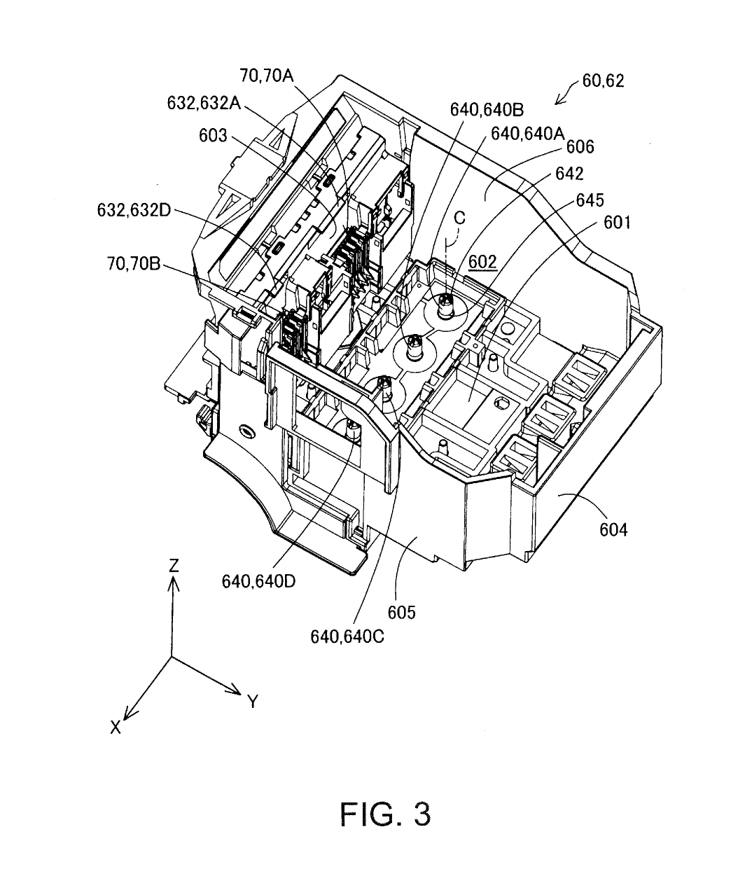

FIG. 2 is a top view of the carriage 62. FIG. 3 is a perspective view of the carriage 62. FIG. 2 shows the carriage 62 in a state in which the first cartridge 10 and the second cartridge 20 are attached to the cartridge holder 60.

As shown in FIGS. 2 and 3, the cartridge holder 60 includes five walls 601, 603, 604, 605, and 606. The recess formed by the five walls 601, 603, 604, 605, and 606 is a cartridge attachment portion 602 for receiving attachment of the first cartridge 10 and the second cartridge 20. As shown in FIG. 2, the cartridge attachment portion 602 includes a first attachment portion 608 that is located on the +X direction side and to which the first cartridge 10 is attached, and a second attachment portion 609 that is located on the −X direction side and to which the second cartridge 20 is attached. The cartridge attachment portion 602 has an opening on an upper side (+Z direction side), and the first cartridge 10 and the second cartridge 20 are attached to and detached from the cartridge holder 60 via this opening. The wall 601 is also referred to as a “device-side bottom wall 601”. The wall 603 is also referred to as a “first device-side side wall 603”. The wall 604 is also referred to as a “second device-side side wall 604”. The wall 605 is also referred to as a “third device-side side wall 605”. The wall 606 is also referred to as a “fourth device-side side wall 606”.

The device-side bottom wall 601 forms a bottom face of the cartridge attachment portion 602 having a recessed shape. The first to fourth device-side side walls 603, 604, 605, and 606 rise from the device-side bottom wall 601 in the +Z direction, and form side faces of the cartridge attachment portion 602 having a recessed shape. The first device-side side wall 603 and the second device-side side wall 604 oppose each other in the Y direction. The first device-side side wall 603 is located on the −Y direction side, and the second device-side side wall 604 is located on the +Y direction side. The third device-side side wall 605 and the fourth device-side side wall 606 oppose each other in the X direction. The third device-side side wall 605 is located on the +X direction side, and the fourth device-side side wall 606 is located on the −X direction side.

As shown in FIG. 3, the cartridge holder 60 further includes a plurality of liquid supply needles 640, and a plurality of contact mechanisms 70 that each include a device-side terminal. In the present embodiment, four liquid supply needles 640 are provided. When the four liquid supply needles 640 are distinguished therebetween, reference signs “640A”, “640B”, “640C”, and “640D” are used. In the present embodiment, two contact mechanisms 70 are provided. When the two contact mechanisms 70 are distinguished therebetween, reference signs “70A” and “70B” are used.

The liquid supply needles 640 are provided in the cartridge attachment portion 602 inside the carriage 62 (cartridge holder 60). The liquid supply needles 640 each include therein a flow passage for allowing liquid to flow. The liquid supply needles 640 are received by corresponding liquid supply units 180 and 280 (FIG. 2) of the first cartridge 10 and the second cartridge 20. Accordingly, respective types of liquid contained in the first cartridge 10 and the second cartridge 20 are introduced to the flow passages inside the corresponding liquid supply needles 640. The types of liquid introduced to the liquid supply needles 640 are supplied to the head 63.

Each liquid supply needle 640 is a member that extends from the device-side bottom wall 601 in the +Z direction, and includes a base end portion 645 and a leading end portion 642. The liquid supply needle 640 has a columnar shape on the base end portion 645 side, and has an approximately conical shape whose outer diameter decreases toward the +Z direction side, on the leading end portion 642 side. The base end portion 645 forms an end portion of the liquid supply needle 640 on the −Z direction side. The leading end portion 642 forms an end portion of the liquid supply needle 640 on the +Z direction side. An introduction hole is formed in the leading end portion 642 for introducing liquid supplied from the first cartridge 10 or the second cartridge 20 to the internal flow passage. The liquid supply needle 640 has a central axis C extending along the Z axis.

The four liquid supply needles 640A to 640D (FIG. 3) are arranged side by side in the X direction. Three liquid supply needles 640A to 640C out of the four liquid supply needles are arranged in the second attachment portion 609. The three liquid supply needles 640A to 640C are respectively inserted into three corresponding liquid supply units 280 included in the second cartridge 20. Accordingly, the different types of liquid contained in the second cartridge 20 respectively flow into the three liquid supply needles 640A to 640C. In the present embodiment, yellow ink flows into the liquid supply needle 640A, magenta ink flows into the liquid supply needle 640B, and cyan ink flows into the liquid supply needle 640C. One liquid supply needle 640D out of the four liquid supply needles is inserted into one liquid supply unit 180 included in the first cartridge 10. Accordingly, liquid (black ink, in the present embodiment) contained in the first cartridge 10 flows into the liquid supply needle 640D.

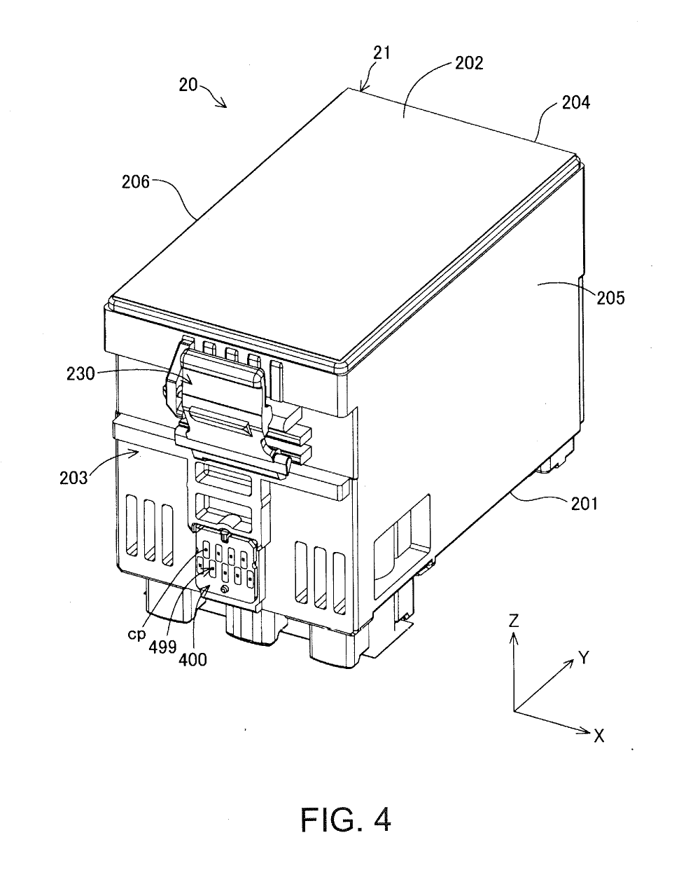

The contact mechanisms 70 are provided in the first device-side side wall 603. The contact mechanism 70A includes device-side terminals (device-side terminal group) that respectively come into contact with contact portions cp on a circuit board 400 (refer to FIG. 4) provided in the second cartridge 90 in a state in which the second cartridge 20 is attached to the second attachment portion 609 (hereinafter, simply referred to as a “attached state”). The contact mechanism 70B includes device-side terminals (device-side terminal group) that respectively come into contact with contact portions on a circuit board provided in the first cartridge 10 when the first cartridge 10 is attached.

The cartridge holder 60 further includes device-side engaging portions 632. The device-side engaging portions 632 are provided in the first device-side side wall 603, and are provided on the +Z direction side relative to the contact mechanism 70. Two device-side engaging portions 632 are provided. When the two device-side engaging portions 632 are distinguished therebetween, reference signs “632A” and “632D” are used. The device-side engaging portions 632 are each a protruding piece that protrudes from the first device-side side wall 603 towards the cartridge attachment portion 602 side (+Y direction side). The device-side engaging portion 632A provided in the second attachment portion 609 locks an engaging member 230 (refer to FIG. 4) of the second cartridge 20 when the second cartridge 20 is attached. The device-side engaging portion 632D provided in the first attachment portion 608 locks an engaging member of the first cartridge 10 when the first cartridge 10 is attached.

A2. Configuration of Cartridge

Cartridges having various configurations can be adopted as the first cartridge 10. In the present embodiment, the cartridge having a configuration described in JP-A-2013-248786 is adopted as the first cartridge 10. In the following, features of the second cartridge 20 will be described in detail. Note that, in the following, the second cartridge 20 may be simply referred to as a “cartridge 20”.

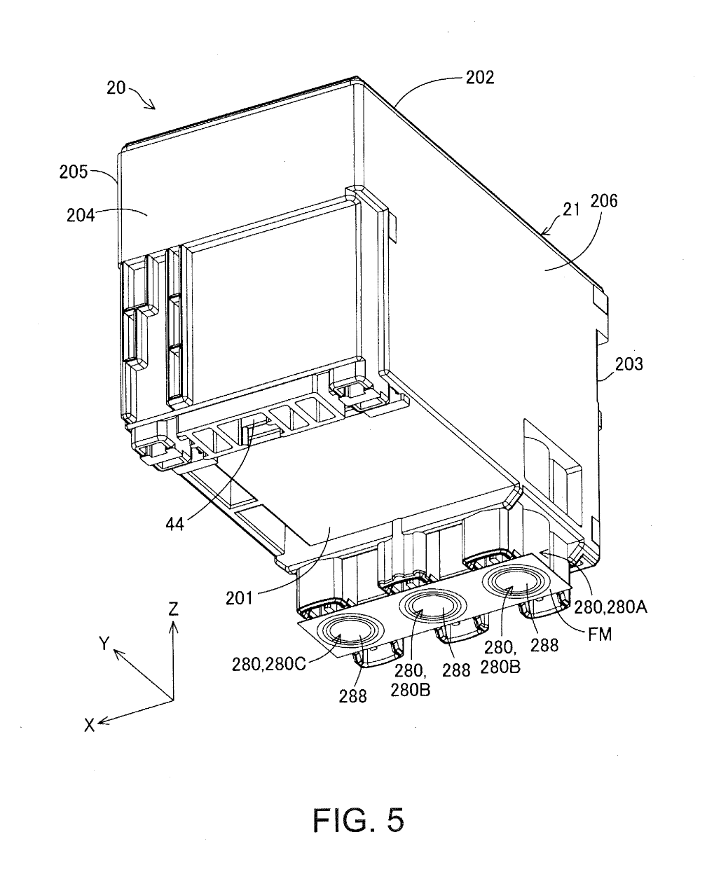

FIG. 4 is a first perspective view of the cartridge 20. FIG. 5 is a second perspective view of the cartridge 20. The sizes of the cartridge 20, namely the length (size in the Y direction), the width (size in the X direction), and the height (size in the Z direction), decrease in order of the length, the height, and the width. Also, the width (size in the X direction) of the cartridge 20 is larger than that of the first cartridge 10. Note that the relationship in size between the length, the width, and the height of the cartridge 20 can be freely changed. The sizes may increase in order of the height, the length, and the width, or may be equal.

The external shape of the cartridge 20 is substantially a rectangular parallelepiped shape. The cartridge 20 includes six faces. The six faces are a bottom face 201, an upper face 202, a first side face (front face) 204, a second side face (rear face) 203, a third side face (left side face) 205, and a fourth side face (right side face) 206. The six faces 201 to 206 constitute a case 21 of the cartridge 20. The faces 201 to 206 are each flat. A face being flat includes a case where the entire face is completely flat and a case where a portion of the face includes recesses and protrusions. As shown in FIG. 5, portions in which later-described liquid supply units 280 and an atmosphere communication port 44 are formed protrude from the bottom face 201. The shape of the faces 201 to 206 in plan view are each substantially rectangular.

The bottom face 201 corresponds to a concept that includes a wall forming the bottom wall of the cartridge 20 in the attached state, and may also be referred to as a “bottom wall 201”. Also, the upper face 202 corresponds to a concept that includes a wall forming the upper wall of the cartridge 20 in the attached state, and may also be referred to as an “upper wall 202”. Also, the first side face 204 corresponds to a concept that includes a wall forming the front face wall of the cartridge 20 in the attached state, and may also be referred to as a “front face wall 204”. Also, the second side face 203 corresponds to a concept that includes a wall forming the rear face wall of the cartridge 20 in the attached state, and may also be referred to as a “rear face wall 203”. Also, the third side face 205 corresponds to a concept that includes a wall forming the left side wall of the cartridge 20 in the attached state, and may also be referred to as a “left side face wall 205”. Also, the fourth side face 206 corresponds to a concept that includes a wall forming the right side wall of the cartridge 20 in the attached state, and may also be referred to as a “right side face wall 206”. Note that the “wall” need not be formed by a single wall, and may be formed by a plurality of walls.

The bottom face 201 and the upper face 202 oppose each other in the Z direction. The bottom face 201 is located on the −Z direction side, and the upper face 202 is located on the +Z direction side. The bottom face 201 faces the device-side bottom wall 601 (FIG. 3) of the cartridge holder 60 in the attached state. The bottom face 201 and the upper face 202 are horizontal faces in the attached state. The bottom face 201 and the upper face 202 intersect the first side face 204, the second side face 203, the third side face 205, and the fourth side face 206 at a substantially right angle. The bottom face 201 and the upper face 202 are faces that are parallel to the X axis and the Y axis. The bottom face 201 and the upper face 202 are faces that are orthogonal to the Z axis. When the plane parallel to the X axis and Y axis (a face orthogonal to the Z axis) is defined as an X-Y plane, the bottom face 201 and the upper face 202 are faces that are parallel to the X-Y plane. Note that, in the present embodiment, two faces “crossing” or “intersecting” means any of the states, namely a state in which the two faces are connected together and cross, a state in which an extension of one face crosses the other face, and a state in which an extension of one face crosses an extension of the other face. Also, two faces “opposing” includes a case where another object does not exist between the two faces, and a case where another object exists between the two faces.

The first side face 204 and the second side face 203 oppose each other in the Y direction. The first side face 204 is located on the +Y direction side, and the second side face 203 is located on the −Y direction side. The first side face 204 faces the second device-side side wall 604 (FIG. 3) of the cartridge holder 60 in the attached state. The second side face 203 faces the first device-side side wall 603 (FIG. 3) of the cartridge holder 60 in the attached state. The first side face 204 and the second side face 203 are vertical faces in the attached state. The first side face 204 and the second side face 203 intersect the bottom face 201, the upper face 202, the third side face 205, and the fourth side face 206 at a substantially right angle. The first side face 204 and the second side face 203 are parallel to the X axis and the Z axis. The first side face 204 and the second side face 203 are faces orthogonal to the Y axis. When the plane parallel to the X axis and Z axis (a face orthogonal to the Y axis) is defined as an X-Z plane, the first side face 204 and the second side face 203 are faces parallel to the X-Z plane.

The third side face 205 and the fourth side face 206 oppose each other in the X direction. The third side face 205 is located on the +X direction side, and the fourth side face 206 is located on the −X direction side. The third side face 205 faces the first cartridge 10 in the attached state. The fourth side face 206 faces the fourth device-side side wall 606 (FIG. 3) of the cartridge holder 60 in the attached state. The third side face 205 and the fourth side face 206 intersect the bottom face 201, the upper face 202, the first side face 204, and the second side face 203 at a substantially right angle. The third side face 205 and the fourth side face 206 are faces parallel to the Y axis and the Z axis. The third side face 205 and the fourth side face 206 are faces orthogonal to the X axis. When the plane parallel to the Y axis and Z axis (a face orthogonal to the X axis) is defined as an Y-Z plane, the third side face 205 and the fourth side face 206 are faces parallel to the Y-Z plane.

As shown in FIG. 4, the cartridge 20 includes, on the second side face 203, the circuit board 400 and the lever-shaped engaging member 230 to be locked to the device-side engaging portion 632A. A cartridge-side terminal group 499 is provided on the surface of the circuit board 400. The cartridge-side terminal group 499 includes the contact portions cp that come into contact with the contact mechanism 70 provided in the cartridge attachment portion 602. A storage device electrically connected to the cartridge-side terminal group 499 is provided on a back face of the circuit board 400. The storage device stores information regarding the cartridge 20. The information regarding the cartridge 20 includes information indicating the type of liquid contained therein, information indicating the amount of liquid contained therein, information indicating the consumed amount of liquid, and information indicating the manufacturing date of the cartridge 20, for example. The controller 61 provided in the liquid ejection device 50 can read these pieces of information from the storage device provided in the circuit board 400 via the contact mechanism 70 and the cartridge-side terminal group 499.

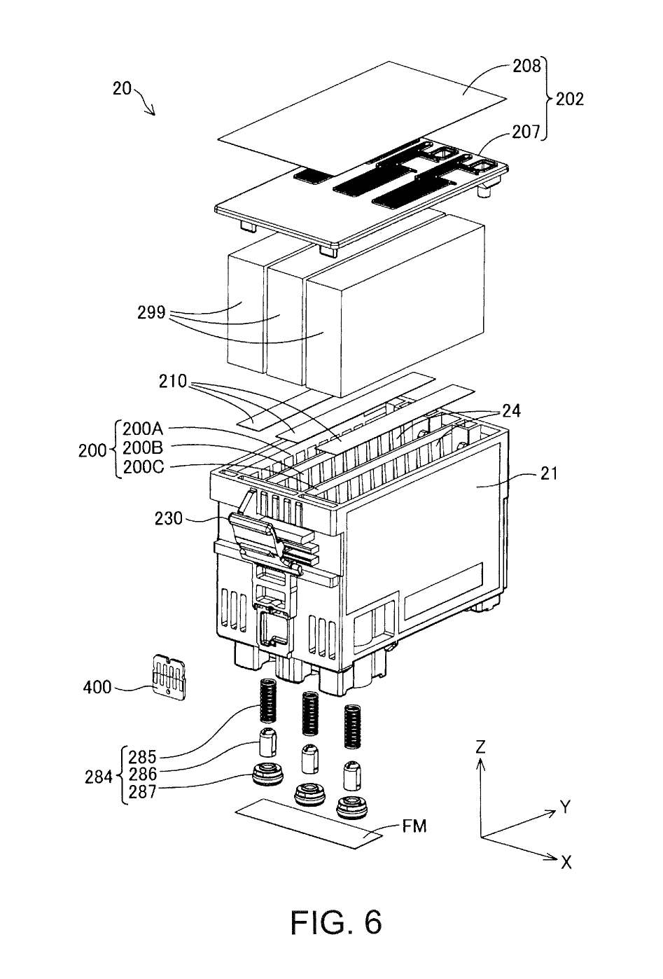

FIG. 6 is an exploded perspective view of the cartridge 20. A plurality of (three, in the present embodiment) liquid containing chambers 200A, 200B, and 200C that respectively contain the plurality of types of liquid (yellow ink, magenta ink, and cyan ink, in the present embodiment) described above are provided inside the case 21 of the cartridge 20. The three liquid containing chambers 200A to 200C are separated from each other by side walls 24 that are provided inside the case 21 along the Y-Z plane such that the three types of liquid do not mix with each other. The liquid containing chamber 200A contains yellow ink, the liquid containing chamber 200B contains magenta ink, and the liquid containing chamber 200C contains cyan ink. For example, the plurality of types of liquid (yellow ink, magenta ink, and cyan ink) contained in the cartridge 20 are each dye ink. A filter 210 is fixed to a bottom portion of each of the liquid containing chambers 200A, 200B, and 200C, and a liquid absorber 299 having a rectangular parallelepiped shape is placed on the filter 210. The liquid absorber 299 is a member for retaining (absorbing) liquid using a predetermined capillary force. The liquid absorber 299 may be a foamable member such as urethane foam or a fibrous member formed by bundling polypropylene that is processed into a fibrous state, for example. The upper face 202 of the case 21 of the cartridge 20 is constituted by a lid member 207 and an upper face film member 208 attached on the lid member 207. In the following, the liquid containing chamber 200A, the liquid containing chamber 200B, and the liquid containing chamber 200C will be each referred to as a liquid containing chamber 200 when they are not specifically distinguished therebetween. Note that, although the cartridge 20 includes the three liquid containing chambers 200 in the present embodiment, one or two liquid containing chambers 200 may be provided, or four or more liquid containing chambers 200 may be provided.

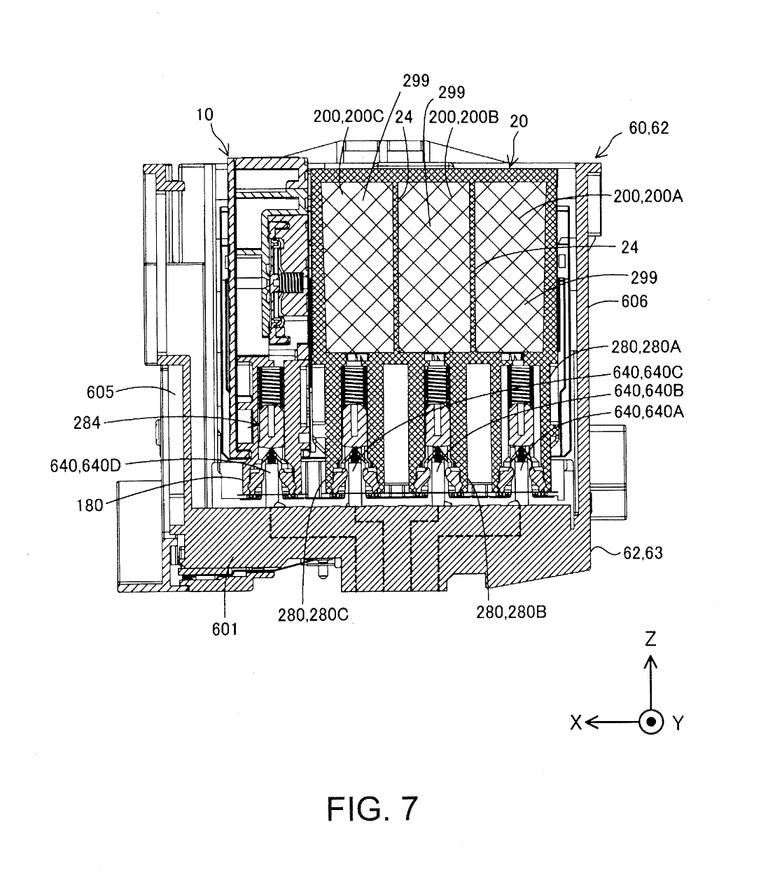

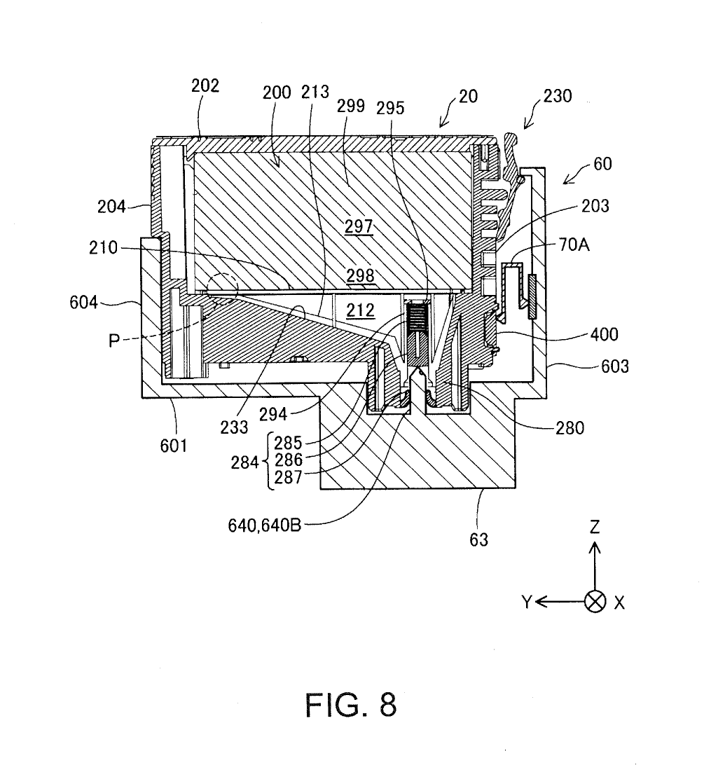

FIG. 7 is a cross-sectional view taken along line VII-VII in FIG. 2. FIG. 8 is a cross-sectional view taken alone line VIII-VIII in FIG. 2. A cross-sectional configuration across the liquid containing chamber 200A is shown in FIG. 8. The cross-sectional configuration across the liquid containing chamber 200B and that of the liquid containing chamber 200C are almost the same as the cross-sectional configuration across the liquid containing chamber 200A. As shown in FIG. 7, when the first cartridge 10 is attached to the cartridge holder 60, the liquid supply needle 640D is inserted into the liquid supply unit 180 of the first cartridge 10. Accordingly, black ink is supplied to the head 63 from the first cartridge 10 via the liquid supply needle 640D. The first cartridge 10 does not include a liquid absorber for retaining (absorbing) ink. That is, the first cartridge 10 is a direct liquid-type cartridge.

As shown in FIG. 8, the cartridge 20 includes the liquid containing chamber 200 in which the liquid absorber 299 is arranged, the liquid supply unit 280, a bubble trap chamber 212 in which the liquid supply unit 280 is provided, and the thin filter 210. The liquid supply unit 280 is for receiving the liquid supply needle 640, and supplying ink inside the liquid containing chamber 200 to the liquid ejection device 50. The liquid supply unit 280 is provided at a position closer to the second side face 203 than the first side face 204 in the Y direction. In the attached state, the bubble trap chamber 212 is arranged vertically below the liquid containing chamber 200. The filter 210 is provided between the liquid containing chamber 200 and the bubble trap chamber 212. The filter 210 is constituted by a PET nonwoven fabric or a stainless nonwoven fabric. In the present embodiment, the filter 210 is arranged along the horizontal direction in the attached state. Note that the liquid absorber is not arranged inside the bubble trap chamber 212. The liquid containing chamber 200 may also be referred to as a “first chamber”, and the bubble trap chamber 212 may also be referred to as a “second chamber”.

When the cartridge 20 is started to be used, the bubble trap chamber 212 and the liquid containing chamber 200 are mostly filled with ink. When the ink in the liquid containing chamber 200 and the bubble trap chamber 212 is consumed via the liquid supply unit 280, air is introduced into the liquid containing chamber 200 from a later-described atmosphere communication passage 40 following consumption of the ink. That is, the cartridge 20 of the present embodiment is an atmosphere open type cartridge.

The bubble trap chamber 212 has a function of supplying liquid contained in the liquid containing chamber 200 to the liquid supply unit 280, and a function of capturing (trapping) bubbles. The bubble trap chamber 212 stores (1) bubbles that flow in from the liquid containing chamber 200 via the filter 210 when the cartridge is subjected to an impact due to being dropped, (2) bubbles that enter via the liquid supply unit 280 when the liquid supply unit 280 has received the liquid supply needle 640, and (3) bubbles that have grown inside the bubble trap chamber 212. In the present embodiment, since bubbles that have generated or have entered due to some cause are stored inside the bubble trap chamber 212, the occurrence of liquid supply failure can be suppressed.

As shown in FIGS. 7 and 8, when the cartridge 20 is attached, the liquid supply needles 640 are respective inserted into the corresponding liquid supply units 280 of the cartridge 20. With this, yellow ink, magenta ink, and cyan ink are respectively supplied to the head 63 from the liquid containing chambers 200 and the bubble trap chambers 212 via the liquid supply needles 640.

As shown in FIGS. 6 to 8, the liquid supply unit 180 and the liquid supply units 280A to 280C each include a valve mechanism 284. The valve mechanisms 284 open and close respective inner flow passages of the liquid supply units 180 and 280. The valve mechanism 284 includes in order from the leading end side of each of the liquid supply units 180 and 280, a seal portion 287, a valve body 286 that opens when the liquid supply needle 640 comes into contact therewith, and a biasing member 285 for closing the valve body 286. The liquid supply unit 280 includes a valve chamber 294 (refer to FIG. 18). The valve body 286 and the biasing member 285 are arranged in the valve chamber 294.

The seal portion 287 is a substantially ring-shaped member. The seal portion 287 is constituted by an elastic body such as rubber or elastomer, for example. The seal portion 287 is press-fitted into the inside of each of the liquid supply units 180 and 280 from the opening at the leading end thereof. As a result of the seal portion 287 coming into contact with the outer circumferential surface of the liquid supply needle 640 in an airtight manner, in the attached state, the liquid is suppressed from leaking out through a gap between the liquid supply needle 640 and each of the liquid supply units 180 and 280. The seal portion 287 also functions as a valve seat with which the valve body 286 comes into contact when closed.

The valve body 286 is a member having a substantially columnar shape. The valve body 286 is biased in a direction toward the seal portion 287 by the biasing member 285 so as to close a hole formed in the seal portion 287, in a state before the cartridges 10 and 20 are attached to the respective cartridge holders 60 (unattached state). That is, in the unattached state, the valve mechanism 284 is in a closed state.

The biasing member 285 is a compression coil spring. In the attached state of the cartridges 10 and 20, the liquid supply needle 640 pushes the valve body 286 in a direction away from the seal portion 287, and as a result, the biasing member 285 is compressed, and the valve body 286 moves away from the seal portion 287. With this, the valve mechanism 284 enters an open state. An end of the biasing member 285 on the +Z direction side comes into contact with a wall 295 of the valve chamber 294 on the +Z direction side. Therefore, when the biasing member 285 is compressed, the valve chamber 294 restricts the movement of the biasing member 285 toward the +Z direction side.

In an unused state of the cartridge 20, the opening 288 of the liquid supply unit 280 at the leading end is closed by a film FM (FIGS. 5 and 6). The film FM is configured to be broken by the liquid supply needles 640A, 640B, and 640C when the cartridge 20 is attached to the second attachment portion 609 of the cartridge holder 60.

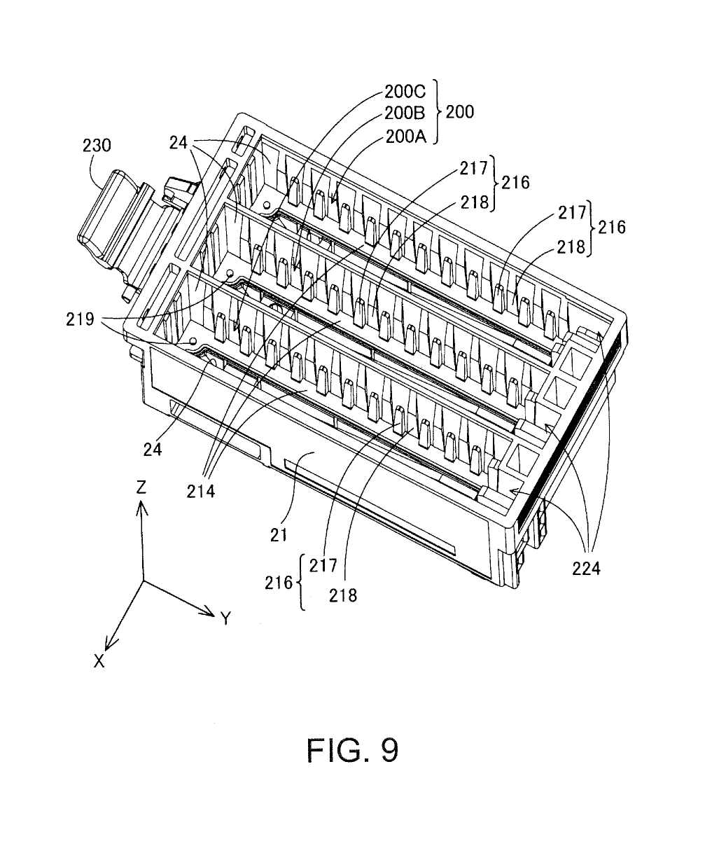

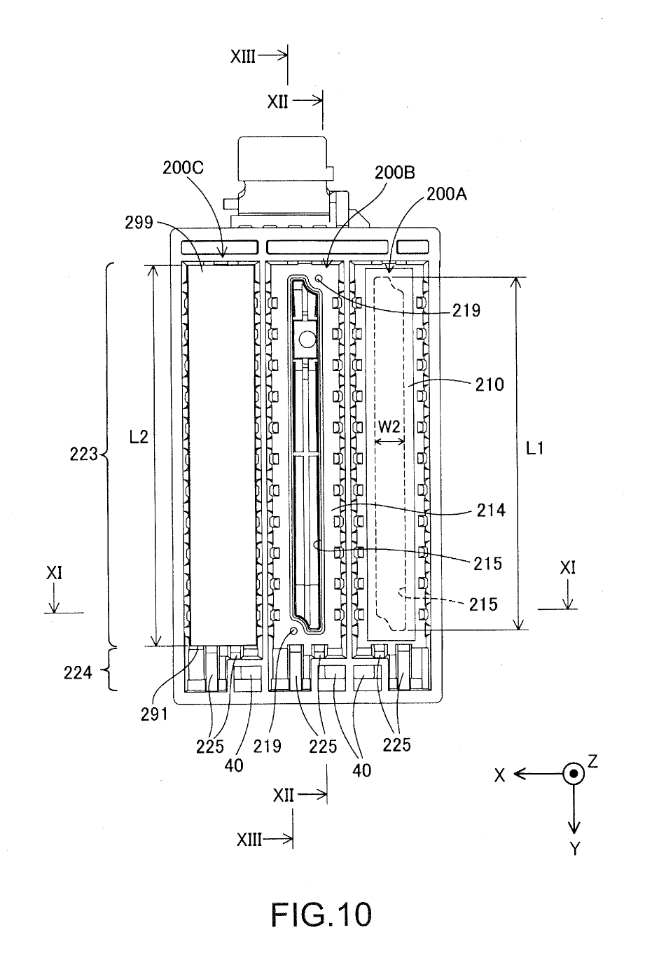

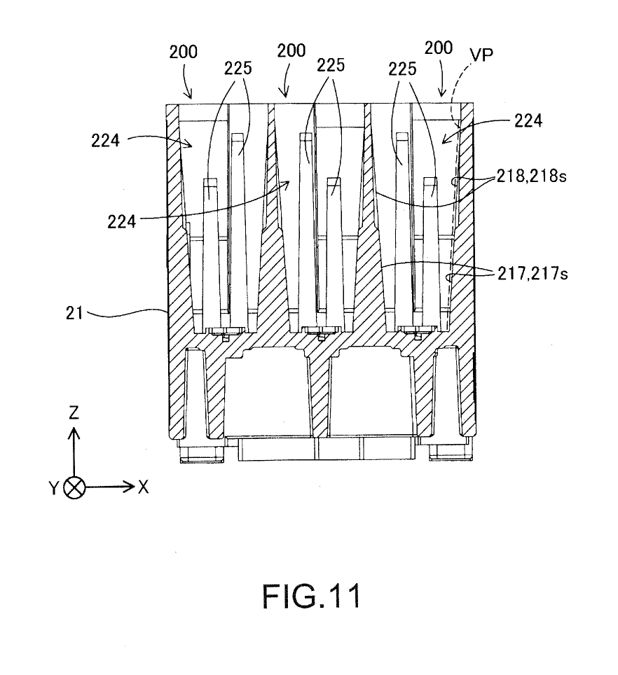

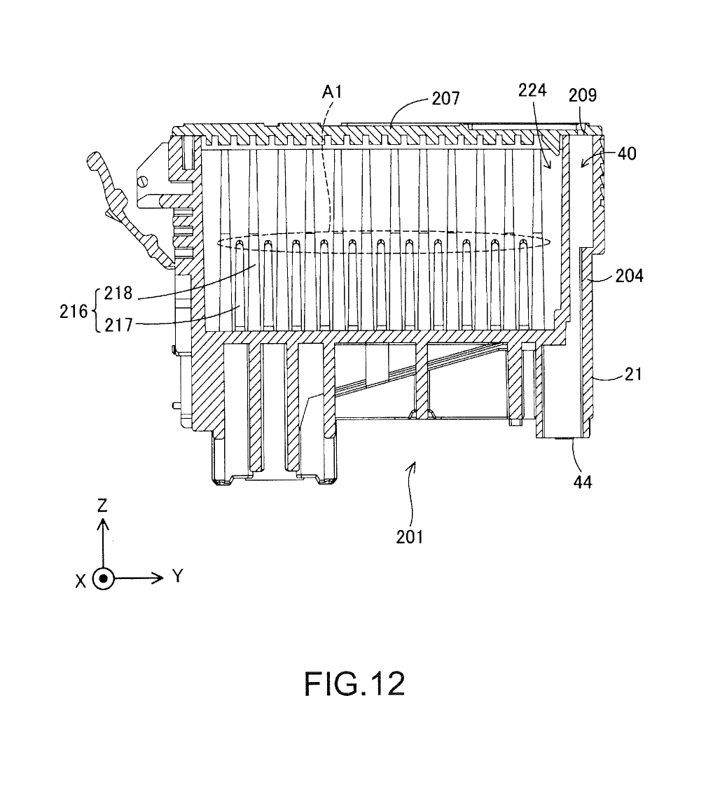

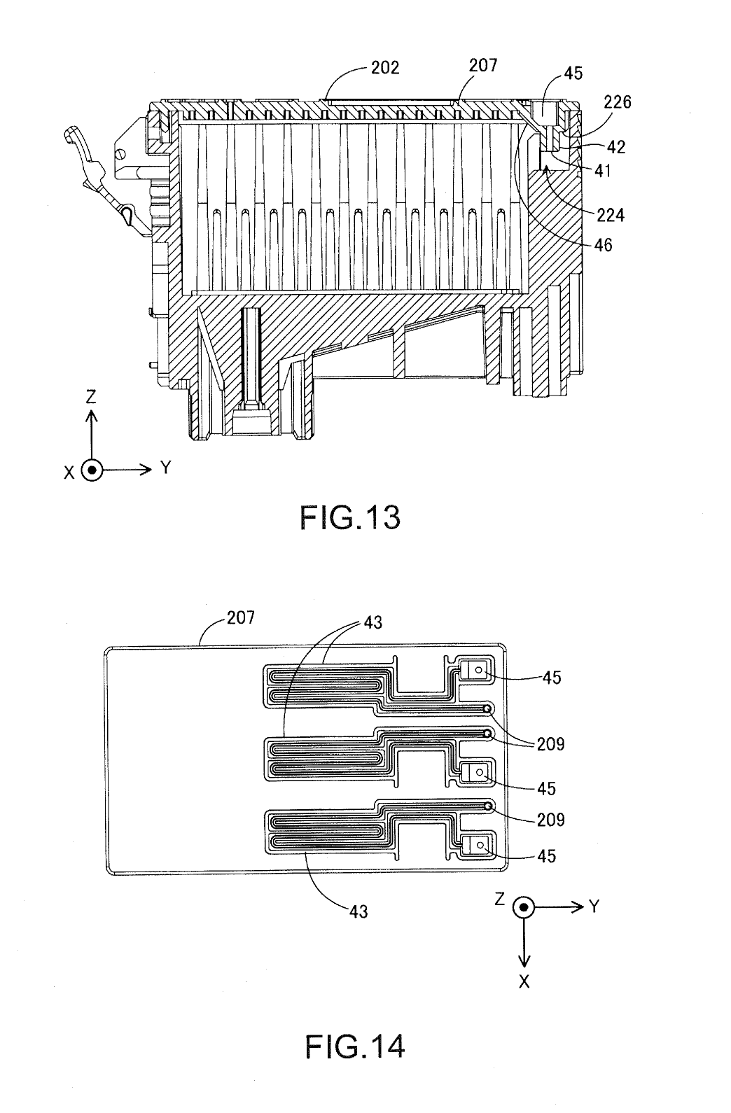

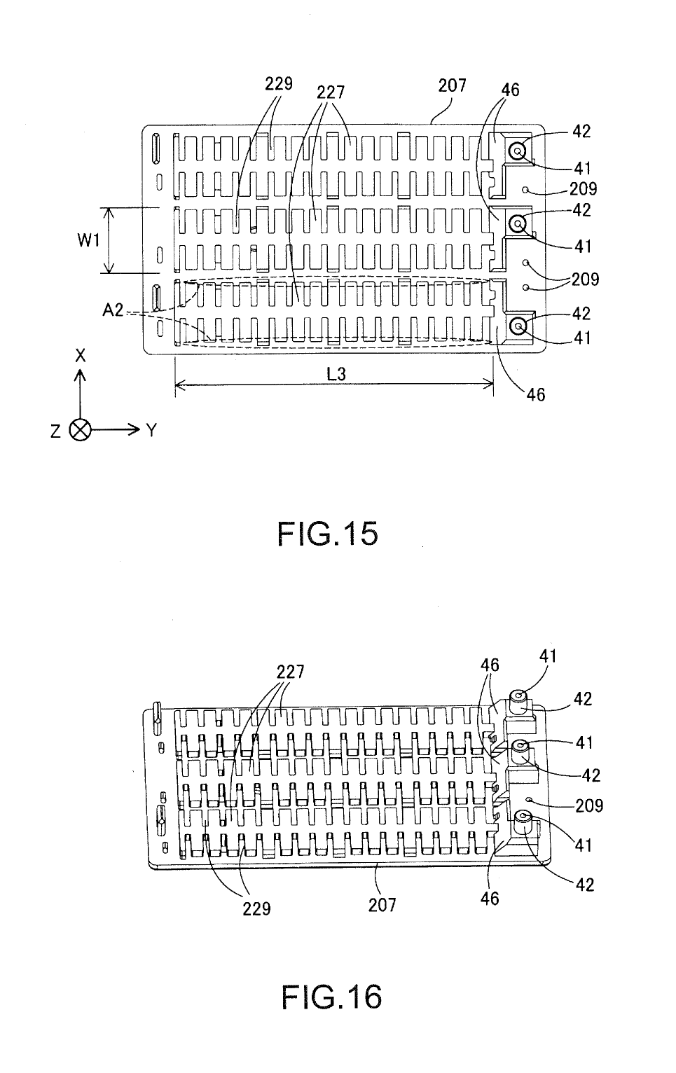

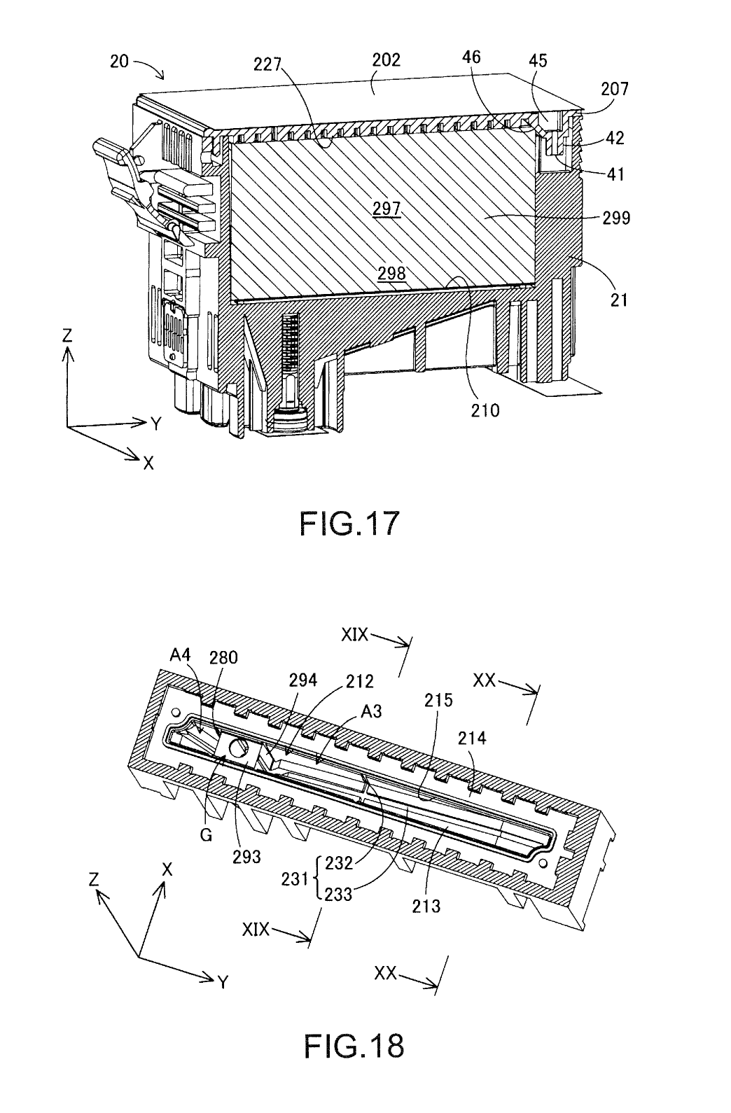

FIG. 9 is a perspective view of a liquid containing chamber 200 viewed from an upper face side. FIG. 10 is a plan view of the liquid containing chamber 200 as seen in a top view. FIG. 11 is a cross-sectional view taken along line XI-XI in FIG. 10. FIG. 12 is a cross-sectional view taken along line XII-XII in FIG. 10. FIG. 13 is a cross-sectional view taken along line XIII-XIII in FIG. 10. FIG. 14 is a plan view of the lid member 207 as seen in a top view. FIG. 15 is a plan view of the lid member 207 as seen in a bottom view. FIG. 16 is a perspective view illustrating a lower face side of the lid member 207. FIG. 17 is a perspective view illustrating a cross-sectional structure of the inside of the cartridge 20. Note that, although the lid member 207 is not shown in FIG. 10, cross sections of the lid member 207 are also shown in FIGS. 12 and 13, which are cross-sectional views taken along lines in FIG. 10.

As shown in FIG. 9, protrusions 216 that protrude toward the inside of the liquid containing chamber 200 are provided on the side walls 24 of the liquid containing chambers 200. The protrusions 216 are provided on inner faces of a pair of side walls 24 that oppose each other in the X direction. Each protrusion 216 extends along the vertical direction (Z direction). Each protrusion 216 includes a portion that is inclined such that the protrusion amount increases from an upper portion of the liquid containing chamber 200 toward a bottom portion 214 of the liquid containing chamber 200. Note that, in the present embodiment, the “bottom portion 214” of the liquid containing chamber 200 refers to, more specifically, a bottom portion of a part, of the liquid containing chamber 200, in which the liquid absorber 299 is arranged (absorber chamber 223 (refer to FIG. 10)).

The protrusions 216 include a plurality of first protrusions 217 and a plurality of second protrusions 218. The height of the second protrusion 218 in the vertical direction is larger than that of the first protrusion 217. In other words, the height of the first protrusion 217 in the vertical direction is smaller than that of the second protrusion 218. Also, a portion of the second protrusion 218 lower than the leading end of the first protrusion 217 in the vertical direction has a protruding amount toward the inside of the liquid containing chamber 200 that is smaller than that of the first protrusion 217. A plurality of these first protrusions 217 and second protrusions 218 are alternatingly arranged in the side walls 24 of the liquid containing chamber 200 with a gap therebetween in the Y direction that is a direction intersecting the vertical direction (Z direction). As shown in FIG. 11, a face 217s of a first protrusion 217 that faces toward the inside of the liquid containing chamber 200 and a face 218s of a second protrusion 218 at a portion higher than the first protrusion 217 that faces toward the inside of the liquid containing chamber 200 are approximately on the same virtual plane VP. On the virtual plane VP, at a boundary between the first protrusion 217 and the second protrusion 218, the protrusion amount of the second protrusion 218 is slightly smaller than that of the first protrusion 217, and a small level difference is formed.

According to the configuration of the protrusions 216 described above, the cross-sectional area of the inner space of the liquid containing chamber 200 in a horizontal direction is smaller on the bottom portion 214 side of the liquid containing chamber 200 than on the upper portion side of the liquid containing chamber 200. Therefore, the liquid absorber 299 arranged in the liquid containing chamber 200 is compressed more on the bottom face side of the liquid containing chamber 200 than on the upper face side thereof. Note that, in the present embodiment, although the cross-sectional area of the inner space of the liquid containing chamber 200 is smaller on the bottom portion 214 side than on the upper portion side as a result of inclining the protrusions 216, the cross-sectional area of the inner space of the liquid containing chamber 200 on the bottom, portion 214 side can be made smaller than that on the upper portion side by inclining the side wall 24.

In the present embodiment, as a result of the protrusions 216 coming into contact with the liquid absorber 299, small spaces are formed between the liquid absorber 299 and the side wall 24. These spaces are connected because the height of the first protrusions 217 is different from that of the second protrusions 218, and are in communication with a later-described air chamber 224. That is, in the present embodiment, as a result of forming the protrusions 216 on the side wall 24 of the liquid containing chamber 200, a space A1 (refer to FIG. 12) through which air or ink can flow to the air chamber 224 is formed between the liquid absorber 299 and the side wall 24.

FIG. 10 shows the manner in which the filter 210 is arranged in the liquid containing chamber 200A, the liquid absorber 299 is arranged in the liquid containing chamber 200C, and neither of the filter 210 and the liquid absorber 299 is provided in the liquid containing chamber 200B. The shape of the bottom portion 214 of the liquid containing chamber 200 is substantially rectangular having a longitudinal direction and a transverse direction. The longitudinal direction runs along the Y direction, and the transverse direction runs along the X direction. Corner portions of the rectangular bottom portion 214 may be rounded. A large opening 215 is formed in the bottom portion 214 of the liquid containing chamber 200. The opening 215 brings the liquid containing chamber 200 and the bubble trap chamber 212 in communication. The filter 210 is provided between the liquid containing chamber 200 and the bubble trap chamber 212 so as to close the opening 215. The liquid containing chamber 200 and the bubble trap chamber 212 are partitioned by the filter 210. In the present embodiment, the capillary force of the filter 210 is larger than the capillary force of any part of the liquid absorber 299.

The outer shape of the filter 210 is rectangular, and the size thereof is larger than that of the opening 215. A positioning projection 219 for positioning the filter 210 is formed in the bottom portion 214 of the liquid containing chamber 200. In the present embodiment, one positioning projection 219 is provided in each of two diagonally opposite corner portions on both ends of the opening 215 in the longitudinal direction (Y direction). When the filter 210 is fixed to the bottom portion 214 of the liquid containing chamber 200, first, the filter 210 is provisionally adhered to the positioning projection 219 outside of the opening 215. Thereafter, the filter 210 is adhered to the entire surrounding area of the opening 215.

As shown in FIG. 10, in the present embodiment, the outer size of the filter 210 is larger than that of the opening 215. However, in the following description, the size of the filter 210 (including length, width, area, and the like) means, not the outer size of the filter 210, but the size of a portion that exhibits a function of a filter, that is, the size of the portion corresponding to the opening 215.

In the present embodiment, the maximum length L1 of the filter 210 along the longitudinal direction (Y direction) is larger than half of the length L2 of the liquid absorber 299 along the longitudinal direction of the filter 210. The ratio of the length L1 of the filter 210 relative to the length L2 of the liquid absorber 299 is 50% or more. The ratio is preferably 75% or more, and is more preferably 90% or more. Also, the ratio may be 100%. In the present embodiment, the ratio is 93%.

In the present embodiment, in both the longitudinal direction (Y direction) and the transverse direction (X direction) of the filter 210, the minimum distance from the outermost periphery of the opening 215 to the outer periphery of the bottom portion 214 is approximately the same. Therefore, a situation can be suppressed in which ink non-uniformly remains at one of the ends in the longitudinal direction of the bottom portion 214 and the edges in the transverse direction thereof.

The liquid containing chamber 200 includes the absorber chamber 223 in which the liquid absorber 299 is arranged, and the air chamber 224 in which the liquid absorber 299 is not arranged. The absorber chamber 223 and the air chamber 224 are arranged side by side in the horizontal direction. Specifically, the absorber chamber 223 and the air chamber 224 are arranged side by side in the longitudinal direction (Y direction) of the filter 210. The filter 210 and the opening 215 are arranged inside the absorber chamber 223 in the liquid containing chamber 200, and are not arranged in the air chamber 224.

In the present embodiment, at least a portion of a side face 291, of the liquid absorber 299, that is adjacent to the air chamber 224 is in contact with the air inside the air chamber 224. The other portion of the side face 291 of the liquid absorber 299 is in contact with a partition rib 225 that is provided extending in the vertical direction inside the air chamber 224. The partition rib 225 restricts the liquid absorber 299 from moving inside the absorber chamber 223 toward the air chamber 224. As shown in FIG. 11, the height of the partition rib 225 in the vertical direction is smaller than the height of the inner space of the liquid containing chamber 200. Therefore, the flow of air inside the air chamber 224 is not disturbed by the partition rib 225. Also, a plurality of the partition ribs 225 having different lengths in the vertical direction are provided inside one air chamber 224.

As shown in FIG. 13, a connection port 41 for connecting the air chamber 224 with the atmosphere communication passage 40 is provided in an upper portion of the air chamber 224. In the present embodiment, the connection port 41 is provided at a leading end of a cylindrical tube 42 that protrudes downward from a ceiling surface 226 of the air chamber 224. The tube 42 is provided in a lower face of the lid member 207 that constitutes the upper face 202 of the liquid containing chamber 200. The tube 42 is in communication with a portion on the upper face side of the lid member 207. The atmosphere communication passage 40 (FIG. 12) to which the connection port 41 is connected is a flow passage for connecting the liquid containing chamber 200 to the atmosphere outside the case 21, and is provided inside the case 21. As shown in FIG. 12, the atmosphere communication passage 40 extends from an upper face side of the case 21 to the bottom face side. The atmosphere communication passage 40 passes through the first side face 204 of the cartridge 20 in the vertical direction. The atmosphere communication port 44, which is a connection port between the atmosphere communication passage 40 and the atmosphere is provided in the bottom face 201 of the case 21.

As shown in FIG. 14, a thin meandering, in a complicated manner, flow passage is provided in an upper face of the lid member 207 that is arranged on the liquid containing chamber 200. This flow passage is referred to as a meandering flow passage 43. The meandering flow passage 43 is demarcated by a groove formed in the upper face of the lid member 207 and an upper face film member 208 (refer to FIG. 6) that is attached to the upper face of the lid member 207. One end of the meandering flow passage 43 is in communication with the tube 42 (FIG. 13) via a recess 45 provided in the upper face of the lid member 207, and the other end thereof is in communication with the atmosphere communication passage 40 (FIG. 12) via a through hole 209 provided in the lid member 207. Therefore, the air chamber 224 and the atmosphere communication passage 40 are connected via this meandering flow passage 43. Note that, since the meandering flow passage 43 connects the air chamber 224 and the atmosphere communication passage 40, the meandering flow passage 43 is also considered to constitute a portion of the atmosphere communication passage 40.

The meandering flow passage 43 increases the distance from the liquid containing chamber 200 to the atmosphere communication port 44, and therefore, the ink inside the liquid containing chamber 200 is suppressed from evaporating and being discharged from the atmosphere communication port 44. Also, the meandering flow passage 43 that constitutes a portion of the atmosphere communication passage 40 is formed to be narrow, and therefore, has a certain capillary force that acts on the ink. Therefore, even if ink has entered into the meandering flow passage 43, the ink can be suppressed from being discharged from the atmosphere communication port 44 via the atmosphere communication passage 40 (meandering flow passage 43). Also, in the present embodiment, even if ink flows backward from the tube 42, the ink is temporarily stored in the recess 45 that exists between the meandering flow passage 43 and the tube 42. Therefore, the ink can be suppressed from entering the meandering flow passage 43.

As shown in FIGS. 15 and 16, in the present embodiment, a level difference portion 227 that protrudes downward is formed in the lower face of the lid member 207 that constitutes the ceiling surface 226 of the liquid containing chamber 200 at a portion corresponding to the absorber chamber 223. The lower face of the level difference portion 227 is flat. Also, the level difference portion 227 is substantially rectangular as seen in a bottom view. The level difference portion 227 comes into contact with the upper face of the liquid absorber 299, and compresses the liquid absorber 299 toward the bottom portion 214 side of the liquid containing chamber 200. Accordingly, a bottom face portion 298 (refer to FIGS. 8 and 17) of the liquid absorber 299 is pressed against the filter 210, holes in the bottom face portion 298 of the liquid absorber 299 decrease in size, and as a result, the capillary force in the bottom face portion 298 is greater than the capillary force in a central portion 297 (refer to FIGS. 8 and 17) of the liquid absorber 299 in a height direction. Note that the thickness of a portion, in the bottom face portion 298 of the liquid absorber 299, in which holes decrease in size is several tens of micrometers or more. In the present embodiment, the level difference portion 227 comes into contact with the upper face of the liquid absorber 299, and therefore, when the cartridge 20 is turned upside down, ink accumulated in the vicinity of the lid member 207 can be again absorbed by the liquid absorber 299 from its contact portion.

In the present embodiment, the maximum width W1 (FIG. 15) of the level difference portion 227 in the transverse direction (X direction) of the filter 210 is larger than the maximum width W2 (FIG. 10) of the filter 210 in the transverse direction of the filter 210. Also, in the present embodiment, the maximum length L3 (FIG. 15) of the level difference portion 227 in the longitudinal direction (Y direction) of the filter 210 is larger than the maximum length L1 (FIG. 10) of the filter 210 in the longitudinal direction of the filter 210. That is, in the present embodiment, the level difference portion 227 is larger than the filter 210. Therefore, the liquid absorber 299 can be favorably compressed toward the filter 210. Note that, as shown in FIGS. 15 and 16, in the present embodiment, the level difference portion 227 is provided with a plurality of stripe shaped notches 229, extending from an end in the +X direction and from an end in the −X direction. As a result of providing these notches 229, a sink mark is suppressed from being generated when the lid member 207 is produced. Note that the notches 229 may be omitted.

In the present embodiment, in a state in which the level difference portion 227 comes into contact with the upper face of the liquid absorber 299, a small amount of space A2 (FIG. 15) exists between the lid member 207 and the liquid absorber 299 around the level difference portion 227. The space A2 is in communication with the air chamber 224. Therefore, even if air has expanded in an upper portion of the liquid absorber 299, the air can be discharged from the atmosphere communication passage 40 via the notches 229, the space A2, and the air chamber 224. Accordingly, the ink can be suppressed from leaking out from the liquid supply unit 280 due to an increase in the pressure inside the liquid containing chamber 200.

As shown in FIGS. 15 and 16, protruding walls 46 are formed in the lower face of the lid member 207 that constitutes the upper face 202 of the case 21. The protruding walls 46 are located between the respective level difference portions 227 and the connection ports 41 (tubes 42), in the lid member 207. Also, the protruding walls 46 are located between the respective absorber chambers 223 and the connection ports 41 (tubes 42), in the liquid containing chamber 200. The width of each protruding wall 46 in the X direction is almost the same as the width of the upper portion of the liquid containing chamber 200. In the present embodiment, a corner of the upper portion of each liquid absorber 299 comes into contact with the corresponding protruding wall 46, as shown in FIG. 17.

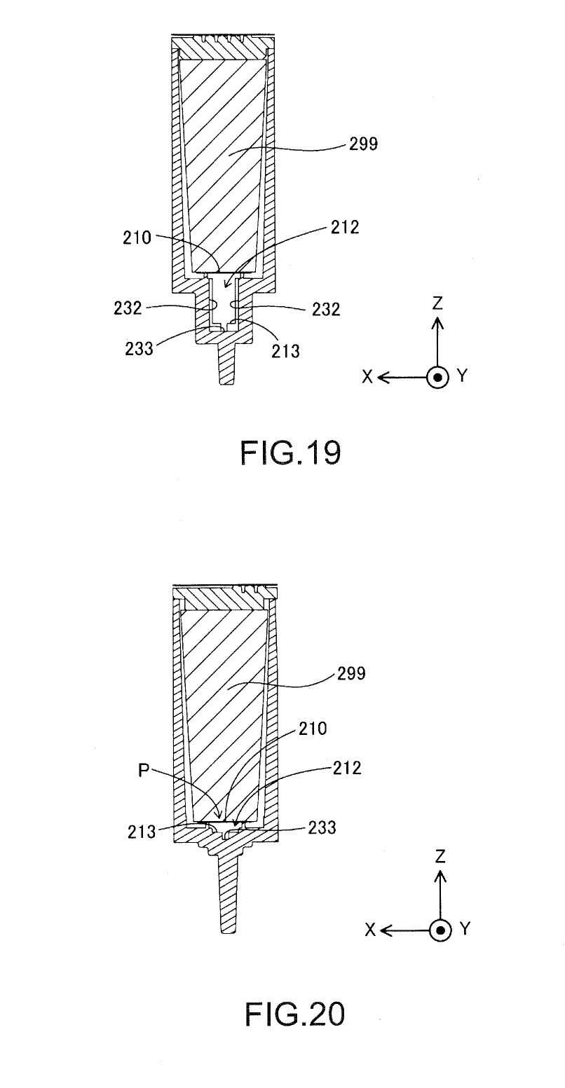

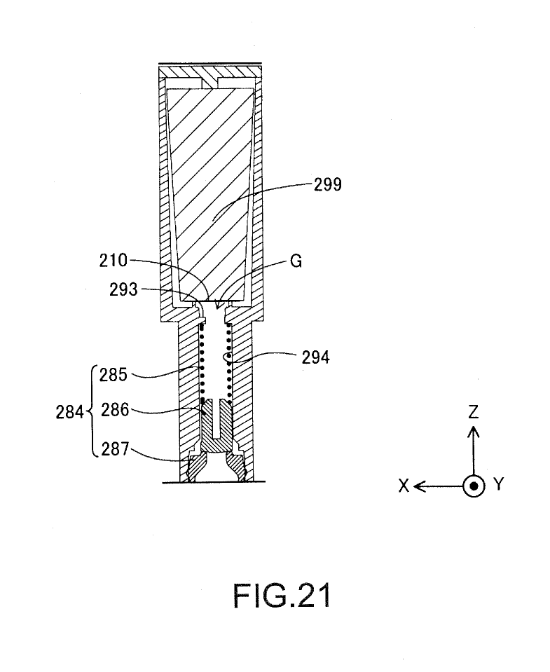

FIG. 18 is a perspective view illustrating a structure of the bubble trap chamber 212. FIG. 19 is a cross-sectional view taken along line XIX-XIX in FIG. 18. FIG. 20 is a cross-sectional view taken along line XX-XX in FIG. 18. FIG. 21 is an X-Z cross-sectional view in the vicinity of the liquid supply unit 280. Note that the structure of the bubble trap chamber 212 corresponding to one liquid containing chamber 200 out of the three liquid containing chambers 200 is shown in FIGS. 18 to 21.

FIG. 18 shows a state in which the bubble trap chamber 212 is seen from the opening 215 formed in the bottom portion 214 of the liquid containing chamber 200. In the present embodiment, the bubble trap chamber 212 includes a liquid guidance passage 231 for guiding liquid to the liquid supply unit 280. Even if bubbles exist inside the bubble trap chamber 212, as a result of ink flowing inside the liquid guidance passage 231, the ink can be allowed to flow smoothly inside the bubble trap chamber 212 to the liquid supply unit 280.

In the present embodiment, a plurality of liquid guidance passages 231 are provided in the bubble trap chamber 212. The plurality of liquid guidance passages 231 include a first liquid guidance passage 232 and second liquid guidance passages 233. Each first liquid guidance passage 232 is formed in a side face of the bubble trap chamber 212 so as to extend from an upper portion to a lower portion, as shown in FIGS. 18 and 19. The second liquid guidance passage 233 is formed in the bottom face 213 of the bubble trap chamber 212 so as to extend in the longitudinal direction (Y direction) of the bubble trap chamber 212 toward the liquid supply unit 280, as shown in FIGS. 18 and 20. In the present embodiment, each liquid guidance passage 231 is constituted by a groove. Also, as shown in FIG. 8, the depth of the second liquid guidance passage 233 from the bottom face 213 increases toward the liquid supply unit 280 such that the cross-sectional area of the flow passage increases toward the liquid supply unit 280. Note that the liquid guidance passages 231 are not limited to grooves, and can be constituted by ribs as well. In the case where the liquid guidance passages 231 are constituted by ribs, pairs of ribs are provided in the bottom face 213 and the side faces of the bubble trap chamber 212 such that ink is allowed to flow between each pair of ribs.

As shown in FIGS. 8 and 18, the bottom face 213 of the bubble trap chamber 212 is inclined such that the height thereof decreases toward the liquid supply unit 280. Also, in the present embodiment, as shown in FIGS. 8 and 20, the distance between at least a portion of the peripheral portion of the filter 210 and the bottom face 213 of the bubble trap chamber 212, specifically the distance between a peripheral portion P of the filter 210 on the farther side from the liquid supply unit 280 and the bottom face 213 of the bubble trap chamber 212 is smaller than the distance between any other portion of the filter 210 (portion other than the peripheral portion P) and the bottom face 213 of the bubble trap chamber 212. In the present embodiment, as a result of configuring the bubble trap chamber 212 such that the angle of inclination of the bottom face 213 relative to the horizontal direction decreases step by step from the liquid supply unit 280 toward the peripheral portion P of the filter 210, the distance between the peripheral portion P of the filter 210 and the bottom face 213 is made smaller than the distance between any other portion (portion other than the peripheral portion P) of the filter 210 and the bottom face 213.

As shown in FIG. 18, in the present embodiment, a circular hole is provided in an upper portion of the valve chamber 294 of the liquid supply unit 280, and a slit-like hole extending in the vertical direction is provided in a side portion of the valve chamber 294. The inner space of the valve chamber 294 is in communication with the bubble trap chamber 212 in an upper and side portions thereof through these holes. Also, in the present embodiment, the bubble trap chamber 212 is divided into two spaces A3 and A4 in the Y direction by the valve chamber 294. However, these two spaces A3 and A4 are in communication through a gap G between the upper face 293 and the filter 210 of the valve chamber 294 as shown in FIGS. 18 and 21.

A3. Effects of First Embodiment

(1-1) According to the present embodiment described above, the relatively large filter 210 is arranged between the liquid containing chamber 200 and the bubble trap chamber 212 of the cartridge 20, as shown in FIGS. 8 and 10. Accordingly, when the cartridge 20 is used, ink can easily flow from the liquid containing chamber 200 to the bubble trap chamber 212 and the liquid supply unit 280. As a result, ink can be suppressed from remaining in a part, of the absorber 299, that is far from the liquid supply unit 280.

(1-2) In the present embodiment, the bottom face portion 298 (FIG. 17) of the liquid absorber 299 is more compressed than the central portion 297 of the liquid absorber 299 in the height direction, and as a result, the capillary force of the bottom face portion 298 of the liquid absorber 299 can be increased. Accordingly, in a state in which the cartridge 20 is filled with ink, a layer of ink is formed in the bottom face portion 298 of the liquid absorber 299. As a result, when the cartridge 20 is subjected to an impact due to being dropped or the like, bubbles can be suppressed from flowing out from the liquid absorber 299 side to the bubble trap chamber 212 side by this ink layer, for example. Therefore, even in a case where the size of the filter 210 is large as in the present embodiment, bubbles can be effectively suppressed from flowing out from the liquid absorber 299 side to the bubble trap chamber 212 side. Also, since bubbles can be suppressed from flowing out from the liquid absorber 299 side to the bubble trap chamber 212 side, ink can be suppressed from excessively returning from the bubble trap chamber 212 side to the liquid absorber 299 side due to bubbles entering into the bubble trap chamber 212. As a result, ink can be suppressed from leaking out from the liquid containing chamber 200 via the atmosphere communication passage 40.

(1-3) In the present embodiment, the cross-sectional area of the inner space of the liquid containing chamber 200 in the horizontal direction is smaller on the bottom portion 214 side of the liquid containing chamber 200 than on the upper portion side of the liquid containing chamber 200, and as a result, the liquid absorber 299 having a rectangular parallelepiped shape is more compressed on the bottom portion 214 side of the liquid containing chamber 200. Therefore, the capillary force of the liquid absorber 299 can be increased toward the bottom portion 214 side, and ink can be allowed to flow smoothly inside the liquid absorber 299 from the upper portion side toward the bottom portion 214 side.

(1-4) In the present embodiment, protrusions 216 (FIG. 9) extending in the vertical direction are provided in the side wall 24 of the liquid containing chamber 200, and each of the protrusions 216 includes the part inclined such that the protruding amount increases from the upper portion toward the bottom portion 214 of the liquid containing chamber 200. Therefore, since the liquid absorber 299 can be compressed more on the bottom portion 214 side of the liquid containing chamber 200, the capillary force of the liquid absorber 299 can be increased toward the bottom portion 214 side. As a result, ink can be allowed to flow smoothly inside the liquid absorber 299 from the upper portion side toward the bottom portion 214 side. Also, as a result of providing the protrusions 216 in the side wall 24, a space is formed between the side face of the liquid absorber 299 and the side wall 24. Therefore, when the air inside the liquid absorber 299 expands due to some cause such as an increase in the ambient temperature, the ink inside the liquid absorber 299 seeps out to the space between the liquid absorber 299 and the side wall 24. Accordingly, the ink inside the liquid containing chamber 200 can be suppressed from leaking to the outside of the cartridge 20 due to an increase in the liquid surface of the ink as a result of expansion of the air inside the liquid absorber 299. Also, because the ink that has seeped out into the space between the liquid absorber 299 and the side wall 24 is again absorbed by the liquid absorber 299, liquid can be suppressed from remaining inside the cartridge 10.

(1-5) In the present embodiment, the first protrusions 217 and the second protrusions 218 that are taller than the first protrusions 217 are alternatingly arranged in the side wall 24 inside the liquid containing chamber 200 with a gap therebetween. Therefore, spaces that are formed when the protrusions 216 come into contact with the liquid absorber 299 are caused to be in communication through portions above the first protrusions 217, and the ink that has seeped out from the liquid absorber 299 can be suppressed from non-uniformly existing inside the liquid containing chamber 200. As a result, ink can be effectively suppressed from leaking to the outside of the cartridge 10. Moreover, in the present embodiment, these spaces are in communication with the air chamber 224, and as a result, the liquid that has seeped out from the liquid absorber 299 is allowed to flow to the air chamber that has a relatively large capacity, and the liquid can be suppressed from leaking to the outside. Also, when air is discharged from the liquid absorber 299 to the above-described spaces, the air is discharged outside via the air chamber 224 and the atmosphere communication passage 40. Accordingly, ink can be effectively suppressed from leaking out from the liquid supply unit 280 side due to expanded air.

(1-6) In the present embodiment, the faces 217s, of the first protrusions 217, that face toward the liquid containing chamber 200 side and faces 218s, of portions of the second protrusions 218 that are higher than the first protrusions 217, that face toward the liquid containing chamber 200 side are approximately on the same virtual plane VP, as shown in FIG. 11, and as a result, the liquid absorber 299 can be favorably compressed from the side faces thereof by the first protrusions 217 and the second protrusions 218. Accordingly, the capillary force of the liquid absorber 299 can be gradually increased from the upper portion toward the bottom portion, and ink can be allowed to flow smoothly toward the bottom portion.

(1-7) In the present embodiment, the positioning projections 219 for positioning the filter 210 are provided in the bottom portion 214 of the liquid containing chamber 200. Therefore, the filter 210 can be easily fixed to the bottom portion 214 of the liquid containing chamber 200.

(2-1) According to the present embodiment, the capillary force of the bottom face portion 298 of the liquid absorber 299 is larger than the capillary force of the central portion 297 of the liquid absorber 299 in the height direction, and therefore ink can be favorably retained in the liquid absorber 299 in the vicinity of the filter 210. As a result, even in a case where the area of the filter 210 is large, when the cartridge 20 has been subjected to an impact due to being dropped or the like, the air existing on the liquid absorber 299 side is unlikely to enter the bubble trap chamber 212 (liquid supply unit 280). Therefore, the occurrence of an ink discharge failure (supply failure) can be suppressed.

(2-2) Moreover, in the present embodiment, since the capillary force of the filter 210 that is arranged below the liquid absorber 299 is larger than the capillary force of the liquid absorber 299, ink is likely to be retained in the filter 210. As a result, the air inside the liquid absorber 299 is unlikely to enter the bubble trap chamber 212. Also, because the filter 210 can collect ink, the ink can be suppressed from remaining in the liquid absorber 299. Note that, in the other embodiments, the capillary force of the filter 210 may be smaller than the capillary force of the bottom face portion 298 of the liquid absorber 299.

(2-3) In the present embodiment, the level difference portion 227 that protrudes downward is formed in the ceiling surface 226 of the liquid containing chamber 200. Therefore, the capillary force of the bottom face portion 298 of the liquid absorber 299 can be easily increased.

(2-4) In the present embodiment, the maximum width W1 (FIG. 15) of the level difference portion 227 in the transverse direction of the filter 210 is larger than the maximum width W2 (FIG. 10) of the filter 210 in the transverse direction of the filter 210. Therefore, the capillary force of the bottom face portion 298 of the liquid absorber 299 can be favorably increased.

(3-1) In the present embodiment, the absorber chamber 223 in which the liquid absorber 299 is arranged and the air chamber 224 in which the liquid absorber 299 is not arranged are arranged side by side in the horizontal direction, in the liquid containing chamber 200, and a side face of the liquid absorber 299 comes into contact with the air inside the air chamber 224. Therefore, the ink that has leaked out from the liquid absorber 299, due to a change in the temperature or internal pressure, a change in the orientation of the cartridge 10, or the like, enters the air chamber 224 adjacent to the liquid absorber 299, and the ink that has entered the air chamber 224 is again absorbed by the liquid absorber 299. Also, in the present embodiment, since the connection port 41 that connects the air chamber 224 and the atmosphere communication passage 40 is provided in an upper portion of the air chamber 224, the likelihood of the ink that has leaked out to the air chamber 224 from the liquid absorber 299 leaking outside the cartridge 10 can be reduced. Therefore, according to the cartridge 20 in the present embodiment, a cartridge can be provided in which ink is unlikely to leak out, and ink can be supplied to the liquid ejection device 50 without waste.

(3-2) In the present embodiment, the connection port 41 that is in communication with the atmosphere is provided at the leading end of the tube 42 that protrudes downward from the ceiling surface 226 of the air chamber 224, and as a result, even if the orientation of the cartridge 10 is changed in a state in which ink exists in the air chamber 224, the ink is unlikely to enter the atmosphere communication passage 40. Therefore, ink can be suppressed from leaking to the outside.

(3-3) In the present embodiment, the atmosphere communication port 44 that is a connection port between the atmosphere communication passage 40 and the atmosphere is provided in the bottom face 201 of the case 21, and the atmosphere communication passage 40 extends from the upper face 202 side of the case 21 to the bottom face 201 side. Therefore, even if the cartridge 20 is turned upside down, because the atmosphere communication port 44 faces upward, ink is unlikely to leak outside of the cartridge 10.

(3-4) In the present embodiment, since the meandering flow passage 43 that is a part of the atmosphere communication passage 40 exerts a capillary force on ink, even if the ink enters the meandering flow passage 43, the ink is unlikely to leak outside. Also, even if the ink has entered the meandering flow passage 43, because the air flows into the meandering flow passage 43 from the atmosphere communication passage 40 as the ink inside the liquid containing chamber 200 is consumed, it is possible for the ink inside the meandering flow passage 43 to again return to the liquid containing chamber 200 via the air chamber 224.

(3-5) In the present embodiment, the protruding wall 46 that protrudes downward is provided in the upper face 202 of the case 21 so as to be arranged between the absorber chamber 223 and the connection port 41. Therefore, even if the cartridge 20 is turned upside down, ink can be suppressed from flowing from the absorber chamber 223 side to the connection port 41 side. Also, since the protruding wall 46 is provided between the absorber chamber 223 and the connection port 41, the liquid absorber 299 can be suppressed from moving to the air chamber 224 side over the protruding wall 46. Also, in the present embodiment, since the liquid absorber 299 comes into contact with the protruding wall 46, even if the cartridge 20 is turned upside down, the ink accumulated in the vicinity of the lid member 207 can be returned to the liquid absorber 299 from the contact portion between the liquid absorber 299 and the protruding wall 46.

(4-1) According to the present embodiment, since the liquid guidance passage 231 that guides ink to the liquid supply unit 280 is provided in the bubble trap chamber 212, the ink inside the bubble trap chamber 212 can easily flow to the liquid supply unit 280 via the liquid guidance passage 231. Therefore, even if bubbles exist in the bubble trap chamber 212, the flow of ink being hampered by the bubbles can be suppressed. As a result, the occurrence of an ink discharge failure can be suppressed.

(4-2) In the present embodiment, a plurality of liquid guidance passages 231 are provided in the bubble trap chamber 212. Therefore, ink can be allowed to favorably flow to the liquid supply unit 280 inside the bubble trap chamber 212.

(4-3) In the present embodiment, the plurality of liquid guidance passages 231 include the first liquid guidance passage 232 that is formed in the side face of the bubble trap chamber 212 so as to extend downward from the upper portion. Therefore, ink can be allowed to favorably flow from the liquid containing chamber 200 to the bubble trap chamber 212.

(4-4) In the present embodiment, the plurality of liquid guidance passages 231 include the second liquid guidance passage 233 formed so as to extend in the longitudinal direction of the bubble trap chamber 212 toward the liquid supply unit 280. Therefore, the ink inside the bubble trap chamber 212 can be allowed to favorably flow to the liquid supply unit 280.

(4-5) In the present embodiment, the second liquid guidance passage 233 is formed as a groove, and the cross-sectional area of the flow passage increases toward the liquid supply unit 280. Therefore, the flow passage resistance of the second liquid guidance passage 233 can be reduced, and ink is allowed to favorably flow to the liquid supply unit 280.

(4-6) In the present embodiment, the bottom face 213 of the bubble trap chamber 212 is inclined such that the height thereof decreases toward the liquid supply unit 280. Therefore, the ink inside the bubble trap chamber 212 is allowed to favorably flow to the liquid supply unit 280.

(4-7) In the present embodiment, the liquid guidance passage 231 can be configured by a groove or ribs. Therefore, the liquid guidance passage 231 can be formed with a simple structure.

(4-8) In the present embodiment, in at least a portion of the peripheral portion of the filter 210, the distance between the filter 210 and the bottom face 213 of the bubble trap chamber 212 is smaller than the distance between any other portion of the filter 210 and the bottom face 213. Therefore, bubbles are not likely to enter the portion whose distance between the filter 210 and the bottom face 213 is small, from any other portion of the bubble trap chamber 212. As a result, in the portion whose distance between the filter 210 and the bottom face 213 is small, ink can be allowed to favorably flow from the filter 210 to the inside of the bubble trap chamber 212.

(4-9) In the present embodiment, the inside of the valve chamber 294 that constitutes the liquid supply unit 280 is in communication with the bubble trap chamber 212 in an upper and side portions. Therefore, bubbles inside the valve chamber 294 can enter the inside of the bubble trap chamber 212. As a result, the likelihood that bubbles will be discharged from the liquid supply unit 280 can be reduced.

(4-10) In the present embodiment, the bubble trap chamber 212 is divided into the plurality of spaces A3 and A4 by the valve chamber 294, and the plurality of spaces A3 and A4 are in communication via the gap G between the upper face 293 of the valve chamber 294 and the filter 210. Therefore, the space in which bubbles can exist is increased inside the bubble trap chamber 212. As a result, the likelihood that bubbles will be discharged from the liquid supply unit can be reduced.

(5-1) According to the present embodiment, ink can be concentrated in the bottom face portion 298 of the liquid absorber 299 and the filter 210 that is arranged below the liquid absorber 299, and as a result, ink can be smoothly supplied from the liquid containing chamber 200 side to the bubble trap chamber 212 that is arranged below the liquid containing chamber 200. Also, since the liquid guidance passage 231 is provided inside the bubble trap chamber 212, even if bubbles exist inside the bubble trap chamber 212, ink can flow smoothly inside the bubble trap chamber 212. Therefore, the cartridge 20 that can be applied to a liquid ejection device in which ink is ejected at high speed can be provided.

(5-2) The cartridge 20 of the present embodiment includes the valve mechanism 284 constituted by the valve body 286 and the biasing member 285 in the liquid supply unit 280 so as to be able to receive the liquid supply needle 640. Therefore, in a state in which the cartridge 20 is not in use, ink inside the liquid containing chamber 200 can be effectively suppressed from leaking out from the liquid supply unit 280 not only by the film FM but also by the valve mechanism 284.

### B. Second Embodiment

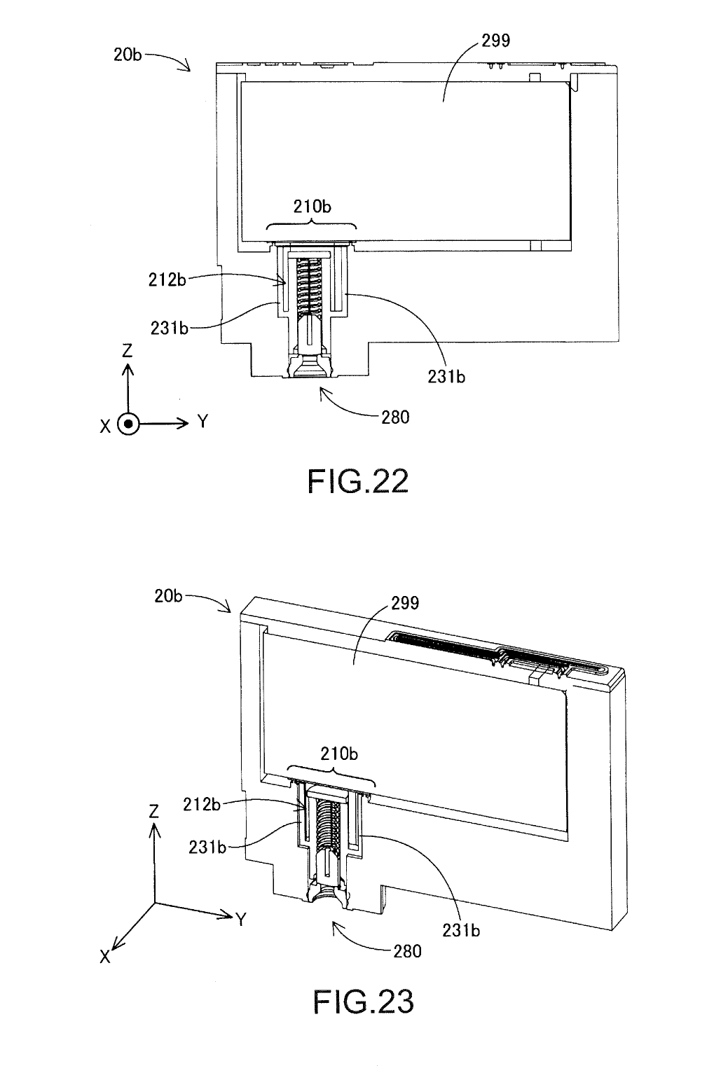

FIG. 22 is a cross-sectional view of a cartridge 20b in a second embodiment. FIG. 23 is a perspective view of the cartridge 20b shown in FIG. 22. In the above-described first embodiment, the length of the filter 210 provided in the cartridge 20 is 50% or more of the length of the liquid absorber 299 in the Y direction. In contrast, in the present embodiment, the size of a filter 210b is smaller than 50% of the length of the liquid absorber 299. Also, a bubble trap chamber 212b has a substantially rectangular parallelepiped shape, and liquid guidance passages 231b are formed in inner faces of the bubble trap chamber 212b on the +Y direction side and on the −Y direction side so as to extend in the vertical direction. According to this second embodiment as well, ink inside the bubble trap chamber 212b is allowed to flow smoothly to the liquid supply unit 280.

### C. Third Embodiment

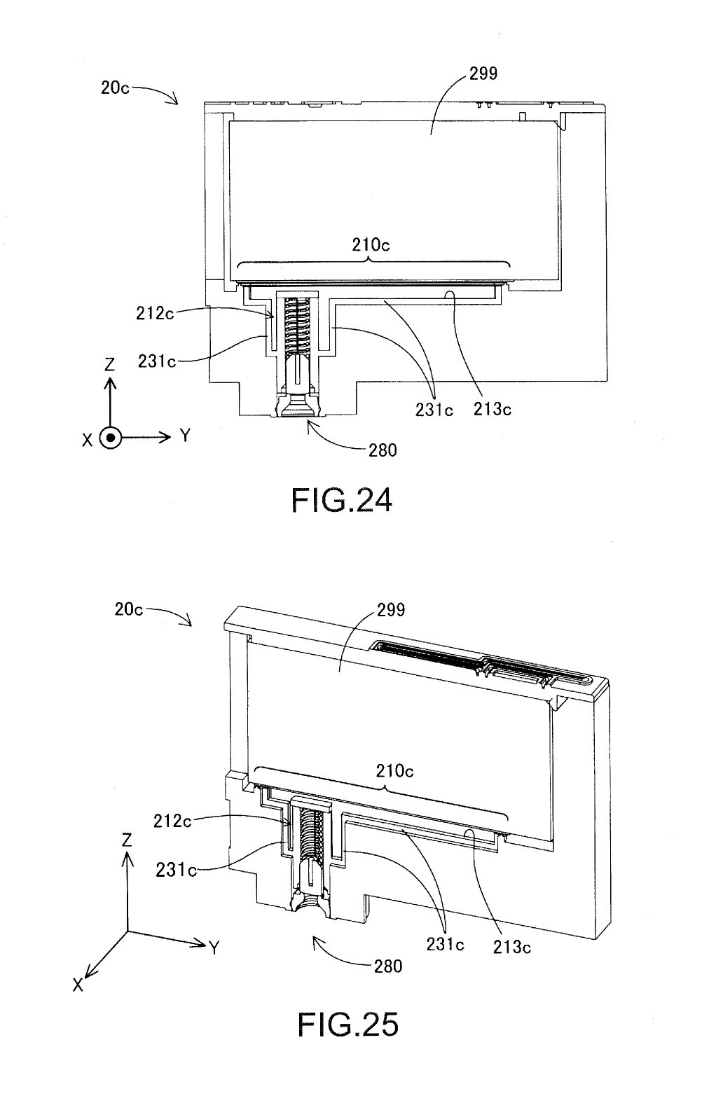

FIG. 24 is a cross-sectional view of a cartridge 20c in a third embodiment. FIG. 25 is a perspective view of the cartridge 20c shown in FIG. 24. In the above-described second embodiment, the length of the filter 210b is smaller than 50% of the length of the liquid absorber 299 in the Y direction. In contrast, in the present embodiment, the length of a filter 210c is 50% or more of the length of the liquid absorber 299, similarly to the first embodiment. Note that, in the present embodiment, unlike the first embodiment, a bottom face 213c of a bubble trap chamber 212c is not inclined toward the liquid supply unit 280, but is flat, and is oriented downward in the vertical direction in the vicinity of the liquid supply unit 280. Also, in the present embodiment, a liquid guidance passage 231c is formed in the horizontal direction in the bottom face 213c of the bubble trap chamber 212c, and is oriented downward in the vertical direction in the vicinity of the bubble trap chamber 212c. According to this third embodiment as well, ink inside the bubble trap chamber 212c is allowed to flow smoothly to the liquid supply unit 280.

### D. Fourth Embodiment

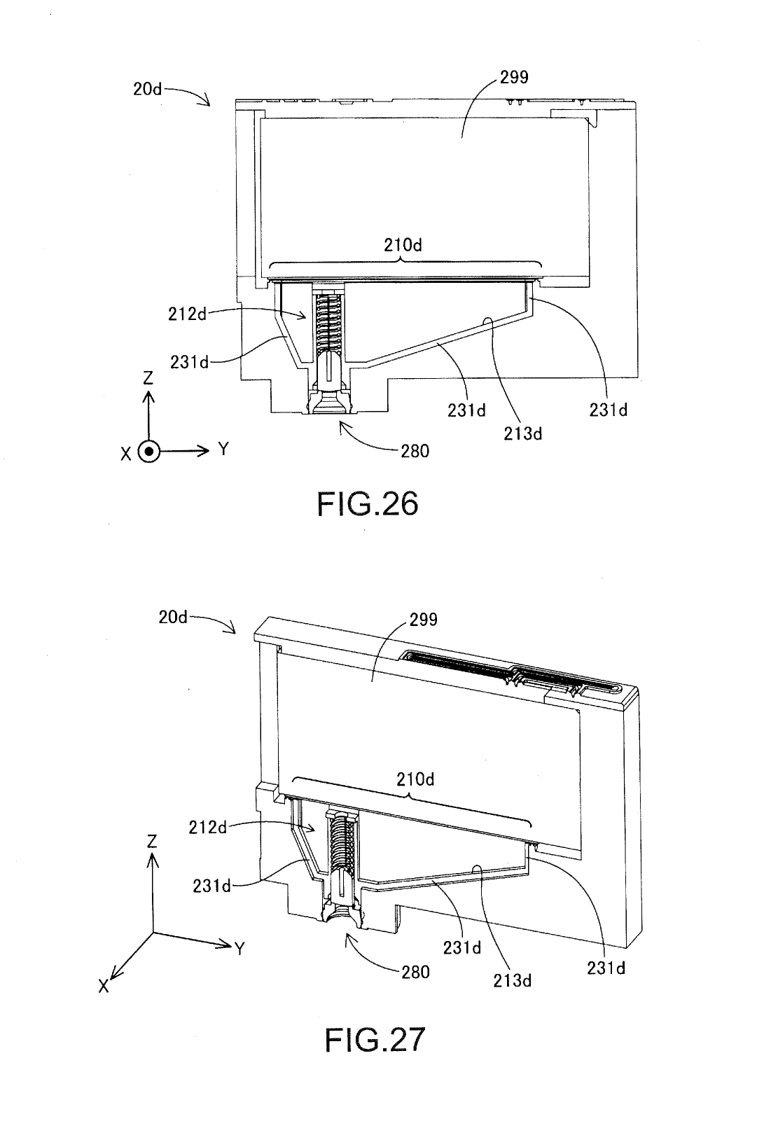

FIG. 26 is a cross-sectional view of a cartridge 20d in a fourth embodiment. FIG. 27 is a perspective view of the cartridge 20d shown in FIG. 26. In the present embodiment, similarly to the first embodiment, a bottom face 213d of a bubble trap chamber 212d is inclined toward the liquid supply unit 280. However, unlike the first embodiment, the bottom face 213d of the bubble trap chamber 212d does not near a filter 210d in a peripheral portion of the filter 210d, and is oriented in the vertical direction. Note that, a liquid guidance passage 231d is formed in the vertical direction in a portion of the bottom face 213d that is oriented in the vertical direction, in the peripheral portion of the filter 210d, and the liquid guidance passage 231d is continuously formed in the inclined bottom face 213d as well so as to reach the liquid supply unit 280. According to this third embodiment as well, ink inside the bubble trap chamber 212d is allowed to flow smoothly to the liquid supply unit 280.

### E. Fifth Embodiment

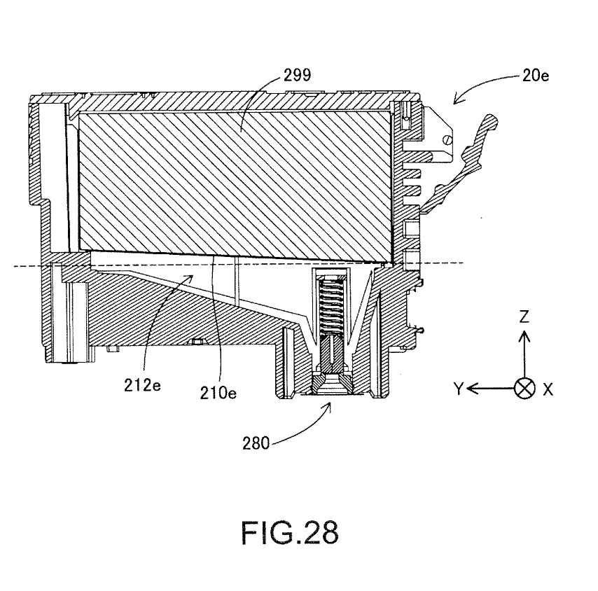

FIG. 28 is a cross-sectional view of a cartridge 20e in a fifth embodiment. In the present embodiment, in an attached state of the cartridge 20e, a filter 210e is inclined relative to the horizontal direction (Y direction) indicated by the broken line. With this configuration, because bubbles inside a bubble trap chamber 212e move upward along the inclined filter 210e, the likelihood that bubbles will be discharged from the liquid supply unit 280 can be reduced. In the present embodiment, the filter 210e is inclined such that the position of the end of the filter 210e on a side farther from the liquid supply unit 280 is higher than that of the other end. Therefore, the position at which bubbles are accumulated can be set apart from the liquid supply unit 280, and the likelihood that bubbles will be discharged from the liquid supply unit 280 can further be reduced.

### F. Other Embodiments

(F1) In the above-described embodiments, the size of the filter 210 is smaller than the size of the bottom portion 214 of the liquid containing chamber 200. In contrast, the entirety of the bottom portion of the liquid containing chamber 200, or the entirety of the upper face of the bubble trap chamber 212 may be constituted by the filter 210.

(F2) The configuration of the cartridge 20 is not limited to those described in the above-described embodiments, and various configurations can be adopted. For example, the cartridge 20 may at least include the liquid containing chamber 200 and the liquid supply unit 280. Some of or all of the filter 210, the bubble trap chamber 212, the liquid absorber 299, the absorber chamber 223, the air chamber 224, the connection port 41, the tube 42, the atmosphere communication passage 40, the atmosphere communication port 44, the meandering flow passage 43, the recess 45, the protrusion 216, the protruding wall 46, the level difference portion 227, the liquid guidance passage 231, the valve body 286, the biasing member 285, the valve chamber 294, the positioning projection 219, and the like can be omitted as appropriate, as long as the cartridge 20 can exhibit at least some of the effects of the above-described embodiments.

(F3) The invention can be applied to, not limited to a printer and its ink cartridge, any liquid ejection devices that consume a liquid other than ink and a cartridge to be used in these liquid ejection devices. For example, the invention can be applied to a cartridge to be used in the following various liquid ejection devices.

(1) Image recording apparatuses such as a facsimile apparatus

(2) Color material ejection recording apparatuses used to manufacture color filters for image display apparatuses such as a liquid crystal display

(3) Electrode material ejection apparatuses used to form electrodes for organic EL (Electro Luminescence) displays, field emission displays (FED), or the like

(4) Liquid consuming apparatuses that eject liquid containing biological organic matter used to manufacture biochips

(5) Sample ejection apparatuses serving as precision pipettes

(6) Lubricating oil ejection apparatuses

(7) Resin solution ejection apparatuses

(8) Liquid consuming apparatuses that perform pinpoint ejection of lubricating oil to precision machines such as a watch and a camera

(9) Liquid consuming apparatuses that eject a transparent resin solution such as a UV-cured resin solution onto substrates in order to form micro-hemispherical lenses (optical lenses) or the like used in optical communication elements or the like

(10) Liquid consuming apparatuses that eject acid or alkaline etchant in order to etch substrates or the like

(11) Liquid consuming apparatuses that include liquid consumption heads for discharging a very small amount of any other kind of droplet.

Note that the “droplet” refers to a state of the liquid discharged from liquid ejection devices, and includes droplets having a granular shape, a tear-drop shape, and a shape with a thread-like trailing end. The “Liquid” mentioned here need only be a material that can be consumed by liquid ejection devices. For example, the “liquid” need only be a material in a state where a substance is in a liquid phase, and a liquid material having a high or low viscosity, sol, gel water, and other liquid materials such as inorganic solvent, organic solvent, solution, liquid resin, and liquid metal (metallic melt) are also included as a “liquid”. Furthermore, the “liquid” is not limited to being a single-state substance, and also includes particles of a functional material made from solid matter, such as pigment or metal particles, that are dissolved, dispersed, or mixed in a solvent, or the like. Representative examples of the liquid include ink such as that described in the above embodiment, liquid crystal, or the like. Here, the “ink” encompasses general water-based ink and oil-based ink, as well as various types of liquid compositions such as gel ink and hot melt ink.

The invention is not limited to the above-described embodiments, and can be achieved by various configurations without departing from the gist thereof. For example, the technical features in the embodiments that correspond to the technical features in the aspects described in the summary of the invention can be replaced or combined as appropriate in order to solve some or all of the problems described above, or in order to achieve some or all of the above-described effects. A technical feature that is not described as essential in the specification can be deleted as appropriate.

What is claimed is:

1. A cartridge that is to be attached to a liquid ejection device including a liquid supply needle, the cartridge comprising:
a liquid supply unit configured to receive the liquid supply needle;
a first chamber in which a liquid absorber is arranged;
a second chamber in which the liquid absorber is not arranged and the liquid supply unit is provided; and
a filter provided between the first chamber and the second chamber,
wherein the length of the filter in a longitudinal direction is larger than half the length of the liquid absorber in the longitudinal direction, and
the capillary force of a bottom face portion of the liquid absorber is larger than the capillary force of a central portion of the liquid absorber in a height direction.

2. The cartridge according to claim 1, wherein the capillary force of the filter is larger than the capillary force of the liquid absorber.

3. The cartridge according to claim 1, wherein a level difference portion that protrudes downward is formed in a ceiling surface of the first chamber.

4. The cartridge according to claim 3, wherein a maximum width of the level difference portion in a transverse direction of the filter is larger than a maximum width of the filter in the transverse direction.

5. The cartridge according to claim 1,
wherein a side wall of the first chamber is provided with a protrusion that protrudes toward the inside of the first chamber,
the protrusion extends in a vertical direction, and
the protrusion includes a part inclined such that a projection amount increases from an upper portion toward a bottom portion of the first chamber.
